(19) United States
(12) Patent Application Publication
(10) Pub. No.: US 2006/0009918 A1
(43) Pub. Date: Jan. 12, 2006

(54) Methods and materials for enhancing the effects of protein modulators

(76) Inventors: Sanku Mallik, Fargo, ND (US); Bidhan C. Roy, Hoover, AL (US); D. K. Srivastava, Fargo, ND (US)

Correspondence Address: Rogalskyj & Weyand, LLP, P.O. Box 44, Livonia, NY, 14487-0044, US

(21) Appl. No.: 10/910,251

(22) Filed: Aug. 3, 2004

Related U.S. Application Data
(60) Provisional application No. 60/586,335, filed on Jul. 8, 2004.

(51) Int. Cl. G06F 19/00; G01N 31/00

(52) U.S. Cl. 702/27

(57) ABSTRACT

Disclosed is a method for enhancing the effect of a protein modulator on a protein by modifying the protein modulator so that the protein modulator binds with the surface of the protein, along with a method for modulating a protein's biological function by contacting the protein with such a modified protein modulator. Also described are modified protein modulators having the formula PM-SP-(LK)ₚ-MCG-(M)_{q}, where PM is a protein modulator which interacts with an active site or allosteric site of a protein; SP is a spacer; LK is a linker; p is 0 or 1; q is an integer greater than or equal to one; MCG is a metal chelating group; and M is a metal ion.

The present application claims the benefit of U.S. Provisional Patent Application Ser. No. 60/586,335, filed Jul. 8, 2004, which provisional patent application is hereby incorporated by reference.

The present invention was made, at least in part, with the support of the National Institutes of Health Grant Nos. 1R01 GM 63404-01A1 and 1P20 RR15566-01. The Federal Government may have certain rights in this invention.

### FIELD OF THE INVENTION

The present invention relates to protein modulation and, more particularly, to methods and materials for enhancing the effects of protein modulators.

### BACKGROUND OF THE INVENTION

The growing knowledge of the molecular basis of human diseases and other biological processes, the availability of human and other genome sequences, rapid solutions of the X-ray crystallographic and nuclear magnetic resonance (“NMR”) structures of enzymes and other proteins in the absence and presence of cognate ligands, and advancements in the predictive capabilities of enzyme-inhibitor complexes and other protein-modulator complexes via molecular modeling techniques have been instrumental in the rational design of drugs against a variety of pathogenic enzymes (Salvatella et al., Chem. Soc. Rev., 32:365-372 (2003); Teodoro et al., Curr. Pharm. Des., 9:1635-1638 (2003) (“Teodoro”); Pfau et al., Curr, Opin. Drug Discov. Devel., 6:437-450 (2003), Acharya et al., Nat. Rev. Drug Discov., 2:891-902 (2003); Benigni et al., Curr. Top. Med. Chem., 3:1289-1300 (2003); and Glen et al., Curr. Med. Chem., 10:763-767 (2003), which are hereby incorporated by reference). Given the structural coordinates of target enzymes in the absence and/or presence of products/inhibitors, efforts are being made to design potent inhibitors as potential drugs by undertaking combined molecular modeling, synthetic organic chemistry, and detailed enzymological approaches (Rastelli et al., Bioorg. Med. Chem. Lett., 13:3257-3260 (2003) and Aronov et al., J. Med. Chem., 41:4790-4799 (1998), which are hereby incorporated by reference). Although these approaches have been successful in some instances, there are fundamental limitations in the structure-based approach to designing drugs.

For example, it is well known that the active site pockets of enzymes have defined spatial dimensions, and these spatial dimensions can limit the extent to which inhibitor structures can be varied when designing drugs (Moy et al., J. Mol. Biol., 302:671-689 (2000); Iverson et al., Biochemistry, 39:9222-9231 (2000); and Yang et al., J. Am. Chem. Soc., 125:7056-7066 (2003), which are hereby incorporated by reference).

Moreover, although the intrinsic flexibility in the protein structures allow binding of structurally unrelated (vis a vis the substrate/product or putative transition state structures) compounds (Teodoro, which is hereby incorporated by reference), it is difficult to predict, a priori, the nature and magnitude of such structural flexibility, and, therefore, it is difficult to exploit structural flexibility in drug designing endeavors. This stricture has led to the widespread employment of combinatorial methods in drug design.

Furthermore, in certain enzyme systems, the target enzyme has several isoenzymes, but only one of the enzymes needs to be inhibited, for example, to alleviate a pathogenic condition (Gasparini et al., Lancet Oncol., 4:605-615 (2003); Elizondo et al., J. Enzyme Inhib. Med. Chem., 18:265-271 (2003); and Gabriella et al., Histochem. J., 24:51-58 (1992), which are hereby incorporated by reference). This can pose a major problem in drug design, since the active site pockets of different isoenzymes do not show extensive variability. This is presumably because the active site structures of isoenzymes catalyzing identical reactions are evolutionarily conserved. Therefore, fine tuning of the lead drug structures so that they could specifically (or preferentially) inhibit one isoenzyme without inhibiting (or minimally inhibiting) other isoenzymes is one of the major challenges of drug design in such systems.

In view of the above-discussed and other problems associated with conventional methods of designing drugs and other protein modulators, a need continues to exist for methods and materials for enhancing the effects of enzyme inhibitors and other protein modulators, and the present invention, in part, is directed to addressing this need.

### SUMMARY OF THE INVENTION

The present invention relates to a method for enhancing the effect of a protein modulator on a protein. The method includes modifying the protein modulator so that the protein modulator binds with the surface of the protein.

The present invention also relates to a method for modulating a protein's biological function. The method includes contacting the protein with a protein modulator modified in accordance with the aforementioned method for enhancing the effect of a protein modulator on a protein.

The present invention also relates to a modified protein modulator having the formula:
PM-SP-(LK)ₚ-MCG-(M)_{q}
wherein PM is a protein modulator which interacts with an active site or allosteric site of a protein; SP is a spacer; LK is a linker; p is 0 or 1; q is an integer greater than or equal to one; MCG is a metal chelating group; and M is a metal ion.

### BRIEF DESCRIPTION OF THE DRAWINGS

FIG. 1 is a table showing various suitable spacer (SP), linker (LK), and metal chelating group (MCG) precursors which can be used in preparing modified protein modulators according to the present invention.

FIG. 2 is a drawing showing structural formulae of several modified protein modulators (1-5) of the present invention along with structural formulae for a non-modified protein modulator (6) and another compound (7).

FIGS. 3A and 3B are synthetic schemes for the preparation of various modified protein modulators of the present invention.

FIG. 4 is a graph showing changes in the UV-VIS spectra of a modified protein modulator of the present invention upon addition of protein.

FIG. 5 is a graph showing the change in absorption maxima as a function of the ratio of enzyme:modified enzyme modulator of the present invention.

FIG. 6 is a series of double-reciprocal plots showing enzyme activity in the presence of various enzyme modulators of the present invention.

FIG. 7A is an image of a three-dimensional ribbon structure of aldolase reductase with a bound inhibitor (fiderastat) and with surface-exposed histidine residues shown. FIG. 7B is a synthetic scheme that can be used to prepare a modified aldol reductase inhibitor of the present invention.

FIG. 8A is an image of a three-dimensional ribbon structure of 17-β-hydroxysteroid dehydrogenase with a bound testosterone and with surface-exposed histidine residues shown. FIG. 8B is a synthetic scheme that can be used to prepare a modified 17-β-hydroxysteroid dehydrogenase inhibitor of the present invention.

FIG. 9A is an image of a three-dimensional ribbon structure of adenylate kinase with a bound AP5218 inhibitor and with surface-exposed histidine residues shown. FIG. 9B is a synthetic scheme that can be used to prepare a modified adenylate kinase inhibitor of the present invention.

FIG. 10A is an image of a three-dimensional ribbon structure of acetolactate synthase showing the location of the inhibitor binding site and surface-exposed histidine residues. FIG. 10B is a synthetic scheme that can be used to prepare a modified acetolactate synthase inhibitor of the present invention.

### DETAILED DESCRIPTION OF THE INVENTION

The present invention relates to a method for enhancing the effect of a protein modulator on a protein. The method includes modifying the protein modulator so that the protein modulator binds with the surface of the protein.

“Protein”, as used herein, refers to any sequence of amino acids having biological function that can be modulated (e.g., increased, decreased, turned on, and/or turned off) by binding with a protein modulator. Illustratively, the protein can be an enzyme. “Enzyme”, as used herein, is meant to refer to any protein that acts as a catalyst, speeding the rate at which a biochemical reaction proceeds but not altering the direction or nature of the reaction.

“Modulator”, as used herein, refers to any material that modulates (e.g., increases, decreases, turns on, and/or turns off) the biological function of a protein. It will be appreciated that a particular modulator will have a modulating effect on only one or on only a select number of proteins. “Protein modulator”, as used herein, refers to any material that modulates the biological function of the protein of interest. For example, where the protein of interest is Protein X, the method of the present invention can be used to enhance the effect, on Protein X, of a modulator of Protein X (i.e., a “Protein X modulator”). As one skilled in the art will appreciate, a modulator of one protein may have modulating effects on other proteins. For example, if Compound A has modulating effects on Protein X and on Protein Y, Compound A is to be deemed to be a modulator of Protein X (i.e., a “Protein X modulator”) as well as a modulator of Protein Y (i.e., a “Protein Y modulator”).

As discussed above, “modulator”, as used herein, refers to any material that modulates (e.g., increases, decreases, turns on, and/or turns off) the biological function of a target enzyme or other target protein. Illustratively, the modulator can be a small molecule (e.g., a molecule having a molecular weight of less than about 1000 grams per mole, such as less than about 900 grams per mole, less than about 800 grams per mole, less than about 700 grams per mole, less than about 600 grams per mole, less than about 500 grams per mole, less than about 400 grams per mole, and/or less than about 300 grams per mole). Additionally or alternatively, the modulator can be one which contains one or more amino acid residues, or it can be one which contains no amino acid residues. Still additionally or alternatively, the modulator can be one which contains one or more aromatic or non-aromatic, homocyclic or heterocyclic rings or ring systems, or it can be one which contains no such rings or ring systems.

“Modulate”, as used herein, is meant to refer to any qualitatively or quantitatively observable increase or decrease, for example, an increase or decrease of at least about 5%, such as of at least about 10%, of at least about 20%, of at least about 30%, of at least about 40%, of at least about 50%, of at least about 60%, of at least about 70%, of at least about 80%, of at least about 90%, of at least about 100%, of at least about 120%, of at least about 150%, and/or of at least about 200%, in the biological function of the protein (such as in the enzymatic activity of an enzyme). Thus, the aforementioned protein modulators can be materials which decrease or otherwise inhibit the biological function of the protein, or they can be materials which increase or otherwise activate the protein's biological function. Illustratively, the protein modulator can be an enzyme inhibitor, for example, as in the case where the protein modulator is a material which decreases a target enzyme's catalytic activity by at least about 1%, such as by at least about 2%, by at least about 3%, by at least about 4%, by at least about 5%, by at least about 10%, by at least about 20%, by at least about 30%, by at least about 40%, by at least about 50%, by at least about 60%, by at least about 70%, by at least about 80%, and/or by at least about 90%. As still further illustration, the protein modulator can be a weak enzyme inhibitor, for example, as in the case where the protein modulator is a material which decreases a target enzyme's catalytic activity by some observable amount but by less than about 50%, such as by some observable amount but by less than about 30%, by at least 1% but by less than about 50%, and/or by at least 1% but by less than about 30%.

The mechanism by which the modulator interacts with the target enzyme or other target protein is not particularly critical to the practice of the present invention. Illustratively, the modulator can be one which interacts in a site-specific manner with a binding site of the target enzyme or other target protein, for example, as in the case where the target enzyme or other target protein contains a binding site located in a cleft or pocket formed in the enzyme's surface.

The mechanism by which interaction of the modulator and the protein's binding site results in modulation of the biological function of the protein is not particularly critical to the practice of the present invention. For example, interaction of the modulator with the protein's binding site can cause a conformational change in the protein which, in turn, results in an increase or decrease in the protein's biological function; and/or interaction of the modulator with the protein's binding site can simply physically block or otherwise alter access to the protein's active site. For example, in the case where the protein is an enzyme having an active site (i.e., a site which is responsible for the enzyme's catalytic activity on a substrate), the protein modulator can be a material which binds to or otherwise interacts with the active site so that the substrate's access to the active site is blocked by the presence of the protein modulator. Alternatively, the enzyme can have an active site and an allosteric binding site, whereby interaction of the protein modulator with the allosteric binding site causes a decrease in the activity of the active site (e.g., via a conformational change in the enzyme, for example, that reduces the substrate's access to the active site or that reduces the catalytic activity of the active site or both). Still alternatively, the enzyme can have an active site and an allosteric binding site, whereby interaction of the protein modulator with the allosteric binding site causes an increase in the activity of the active site (e.g., via a conformational change in the enzyme, for example, that increases the substrate's access to the active site or that increases the catalytic activity of the active site or both).

As will be apparent from the above discussion, the protein modulator can have an inhibitory effect on the enzyme or other protein, or it can have an activating effect on the enzyme or other protein. Irrespective of the nature of the effect of the modulator (i.e., whether it be an inhibitory effect or an activating effect), the present invention relates to methods for enhancing such effects. Thus, where the protein modulator is one which inhibits the biological function of the protein, the present invention enhances the protein modulator's inhibitory effect on the protein's biological function; and, where the protein modulator is one which activates the biological function of the protein, the present invention enhances the protein modulator's activating effect on the protein's biological function.

“Enhance”, as used herein, is meant to refer to any quantitatively or qualitatively observable increase in the protein modulator's effect on the protein's biological function. For example, in the case where the protein modulator inhibits the protein's biological function by X %, the method of the present invention can be used to increase the effect of the protein modulator such that the protein modulator inhibits the protein's biological function by X multiplied by an “enhancement factor” (“F^{E}”), i.e., such that the protein modulator inhibits the protein's biological function by (F^{E}×X) %, where FE is a number greater than one, for example, where FE is greater than about 1.05, greater than about 1.1, greater than about 1.2, greater than about 1.3, greater than about 1.4, greater than about 1.5, greater than about 1.6, greater than about 1.7, greater than about 1.8, greater than about 1.9, greater than about 2, greater than about 2.5 greater than about 3, and/or greater than about 5). Alternatively, in the case where the protein modulator increases or otherwise activates the protein's biological function by X %, the method of the present invention can be used to increase the effect of the protein modulator such that the protein modulator increases or otherwise activates the protein's biological function by X multiplied by an “enhancement factor” (“F^{E}”), i.e., such that the protein modulator increases or otherwise activates the protein's biological function by (F^{E}×X) %, where F^{E} is a number greater than one, for example, where F^{E} is greater than about 1.05, greater than about 1.1, greater than about 1.2, greater than about 1.3, greater than about 1.4, greater than about 1.5, greater than about 1.6, greater than about 1.7, greater than about 1.8, greater than about 1.9, greater than about 2, greater than about 2.5 greater than about 3, and/or greater than about 5).

“Enhance”, as used herein, is also meant to refer to any quantitatively or qualitatively observable increase in the protein modulator's effect on the protein's biological function relative to the protein modulator's effect on other proteins which perform the same biological function and which are modulated by the same protein modulator. For example, where the protein is an enzyme which is one member of a family of isozymes, the method of the present invention can be used to enhance an enzyme inhibitor's ability to inhibit enzymatic activity of the one member relative to other members of the isozyme family.

The method of the present invention includes modifying the protein modulator so that the protein modulator binds with the surface of the protein.

The nature of the interaction by which the modified protein modulator binds to the surface of the protein is not particularly critical. For example, the modified protein modulator can bind to the surface of the protein via covalent interactions, non-covalent interactions, van der Waals interactions, non-van der Waals interactions, hydrogen-bond interactions, non-hydrogen-bond interactions, ionic or other electrostatic interactions, non-electrostatic interactions, metal-complexation interactions, non-metal-complexation interactions, interactions which involve pi electrons, and/or interactions which do not involve pi electrons.

For example, the protein modulator can be modified to contain a tether which bears a metal cation or atom, and the metal cation or atom can bind with an anionic amino acid residue (e.g., a glutamate residue or an aspartate residue) on the surface of the protein, such as via an ionic interaction, or the metal cation or atom can bind with an heteroatom-containing residue (e.g., a histidine residue) on the surface of the protein, such as via a metal complexation interaction. Alternatively, the protein modulator can be modified to contain a tether which bears a functional group which is capable of covalently bonding (e.g., via a disulfide bond or via a bond other than a disulfide bond) with a functional group of an amino acid residue, such as a cysteine residue or a non-cysteine residue, for example, as in the case where a tether bearing a free sulfhydryl group binds with a free sulfhydryl group of a cysteine residue on the surface of the protein via a disulfide bond.

As one skilled in the art will readily appreciate, the nature of the modification to the protein modulator depends on the identity and location of the protein's surface amino acid residue or residues to which the modified protein modulator is to be bonded. Thus, for example, the nature of the modification to the protein modulator can be selected by first identifying an available surface amino acid residue or available surface amino acid residues that are suitable for binding to a modified protein modulator. Illustratively, such suitable surface amino acid residues include amino acid residues that bear heteroatom-containing side chains, such as histidine residues; amino acid residues that bear anionic side chains, such as aspartate and glutamate residues; amino acid residues that bear cationic side chains, such as lysine and arginine residues; amino acid residues that bear aromatic rings, such as phenylalanine and tyrosine; and amino acid residues that bear free sulfhydryl-containing side chains, such as cysteine residues. As one skilled in the art will appreciate, glycine residues and amino acid residues that bear aliphatic side chains (e.g., alanine, valine, leucine, and isoleucine) may be less suitable for binding to a modified protein modulator.

The suitable surface amino acid residue can be located any distance from the binding site of the protein modulator (e.g., the active site (in cases where the protein modulator operates by physically blocking the active site) or an allosteric site (in cases where the protein modulator operates by binding to an allosteric site which then induces a conformational change in the protein which changes the activity or accessibility of the active site)) so long as the protein modulator is modified so as to span the distance between the location of the surface amino acid residue and the location of the protein modulator's binding site. Illustratively, the enzyme or other protein modulator can be modified such that the modified protein modulator binds with the surface of the protein near the protein modulator's active site, allosteric site, or other binding site, for example, as in the case where the suitable surface amino acid residue is located within from about 8 Å to about 20 Å (e.g., at about 8 Å, at about 9 Å, at about 10 Å, at about 11 Å, at about 12 Å, at about 13 Å, at about 14 Å, at about 15 Å, at about 16 Å, at about 17 Å, at about 18 Å, at about 19 Å, or at about 20 Å) from the protein modulator's active site, allosteric site, or other binding site.

Identification of an available surface amino acid residue or available surface amino acid residues that are suitable for binding to a modified protein modulator can be readily achieved for a particular enzyme or other protein by examining the enzyme or other protein's three-dimensional structure in the vicinity of the protein modulator's active site, allosteric site, or other binding site. As discussed above, rapid solutions of X-ray crystallographic and nuclear magnetic resonance (“NMR”) structures of enzymes and other proteins, both in the absence and in the presence of various protein modulators, have made available three-dimensional structures for a wide variety of enzymes and other proteins, and such three-dimensional structures are readily available, for example, at www.rcsb.org/pdb, which is hereby incorporated by reference. More particularly, for a given enzyme or other protein, once the enzyme or other protein's three-dimensional structure is obtained, the three-dimensional structure is examined to identify an available surface amino acid residue or available surface amino acid residues that are suitable for binding to a modified protein modulator, for example, a histidine residue that is located within from about 8 Å to about 20 Å (e.g., at about 8 Å, at about 9 Å, at about 10 Å, at about 11 Å, at about 12 Å, at about 13 Å, at about 14 Å, at about 15 Å, at about 16 Å, at about 17 Å, at about 18 Å, at about 19 Å, or at about 20 Å) or that is otherwise located near the protein modulator's active site, allosteric site, or other binding site.

Having identified a target histidine residue (or other suitable amino acid residue or other site) on the surface of the protein and knowing the location of the protein modulator's active site, allosteric site, or other binding site, the distance between the target site on the surface of the protein and the protein modulator's active site, allosteric site, or other binding site can then be readily determined, for example, by measuring the distance on the enzyme or other protein's three-dimensional structure.

Armed with the identity of the target residue (or other suitable amino acid residue or other site) on the surface of the protein and the distance between the target site on the surface of the protein and the protein modulator's active site, allosteric site, or other binding site, the protein modulator can be modified so that the protein modulator, once modified, binds to the surface of the protein. For example, in the case where the target residue is a histidine residue, the protein modulator can be modified by appending, to the protein modulator, a tether bearing a metal atom or cation, such as Cu²⁺. In the case where the target residue is a cysteine residue, the protein modulator can be modified by appending, to the protein modulator, a tether bearing a free sulfhydryl group. In the case where the target residue is an anionic residue (e.g., an aspartate or glutamate residue), the protein modulator can be modified by appending, to the protein modulator, a tether bearing a cationic moiety (e.g., a metal cation, an amine-based cation, and the like). In the case where the target residue is an cationic residue (e.g., a lysine or arginine residue), the protein modulator can be modified by appending, to the protein modulator, a tether bearing a free anionic moiety (e.g., a free carboxylate, a free sulfonate moiety, and the like). In the case where the target residue bears an aromatic or heterocyclic ring (e.g., a phenylalanine or tyrosine residue), the protein modulator can be modified by appending, to the protein modulator, a tether bearing one or more aromatic or heterocyclic rings.

The tether used in the aforementioned modification of the protein modulator is not particularly critical to the practice of the present invention so long as it is chosen to be of suitable length such that the protein modulator portion of the modified protein modulator can access the active site, allosteric site, or other binding site. For example, in the case where the binding site-to-target surface site distance is D, suitable tether lengths can range from about D to about 5D, such as from about D to about 4D, from about D to about 3D, from about D to about 2D, from about D to about 1.5D, from about 1.2D to about 5D, from about 1.2D to about 4D, from about 1.2D to about 3D, from about 1.2D to about 2D, from about 1.5D to about 5D, from about 1.5D to about 4D, from about 1.5D to about 3D, and/or from about 1.5D to about 2D. Suitable tethers include those which contain alkylene spacers (e.g., having the formula (—CH₂—)ₙ) and/or ethyleneoxy and other alkyleneoxy spacers (e.g., having the formula (—CH₂CH₂O—)ₘ), where n and m are selected based on the distance between the target histidine residue or other target site on the surface of the protein and the protein modulator's active site, allosteric site, or other binding site. Such tethers can also include one or more linkers which facilitate binding of the spacer to the protein modulator portion of the modified protein modulator. Additionally or alternatively, such tethers can include one or more linkers and/or metal chelating groups which, together or individually, facilitate binding of the spacer to the surface-binding functionality (e.g., the Cu²⁺ or other histidine-binding moiety, in the case where the target surface site is a histidine residue; the metal cation, amine-based cation, or other cation in the case where the target residue is an aspartate, glutamate, or other anionic residue; etc.). Suitable metal chelating groups include groups which contain two or more carboxylic acid groups, substituted or unsubstituted amine groups, and the like. Suitable linkers include, for example, those which contain one or more aromatic or non-aromatic rings.

Illustratively, the protein modulator can be modified so as to produce a modified protein modulator having the formula:
PM-SP-(LK)ₚ-(SBM)_{q}
where PM refers to the protein modulator (i.e., the portion of the modified protein modulator which interacts with the active site, allosteric site, or other binding site to modulate the protein's activity); SP refers to a spacer; LK refers to a linker; SBM refers to a surface binding moiety (i.e., to the moiety or moieties that are to interact with the target histidine residue(s) or other target site(s) on the surface of the protein); p is 0 or 1; and q is an integer greater than or equal to one (e.g., from about 1 to about 5, such as 1, 2, 3, 4, or 5).

In the case where q is greater than one, the two or more SBMs can be the same or different. For example, in the case where all SBMs are targeting the same kind of sites on the surface of the protein (e.g., as in the case where q is 2 and both SBMs are targeting histidine residues), the SBMs can be the same (e.g., both can be metal chelating groups coordinated to Cu²⁺ ions); while, in the case where some of the SBMs are targeting one kind of surface site while other SBMs are targeting a different kind of surface site (e.g., as in the case where q is 2 and one SBM is targeting a histidine residue while the other SBM is targeting a lysine or other cationic residue), the SBFs can be different (e.g., one can be a metal chelating group coordinated to a Cu²⁺ ion while the other can be a carboxylate anion).

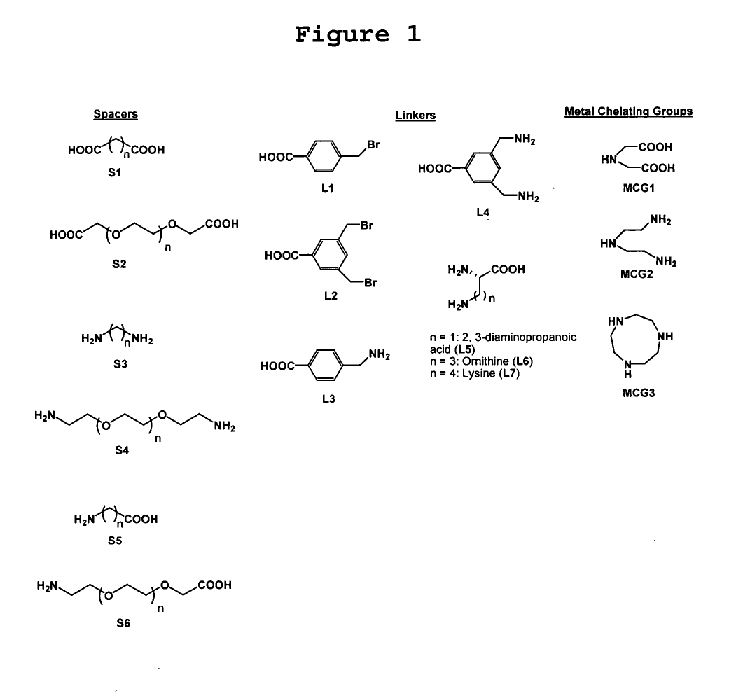

As an illustration of the ways that one can modify protein modulators in the practice of the method of the present invention, and, more particularly, in the case where the SBF is a metal ion (e.g., where the target site on the surface of the protein is a histidine residue or an aspartate, glutamate, or other anionic residue), the modified protein modulators can have formula:
PM-SP-(LK)ₚ-MCG-(M)_{q}
where PM, SP, and LK, p, and q are defined as discussed above, where MCG refers to a metal chelating group, and M is a metal ion, such as Cu²⁺ or another transition metal ion. Suitable spacer (SP), linker (LK), and metal chelating group (MCG) precursors are set forth in FIG. 1. Referring to FIG. 1, S1 (n=1-10) is commercially available; S2 (n=1-2) is commercially available; S2 (n>2, e.g., 3-6) can be prepared in accordance with the procedures described in Wittmann et al., J. Org. Chem., 63:5137-5143 (1998), which is hereby incorporated by reference; S3 (n=2-10) is commercially available; S4 (n=1-2) is commercially available; S4 (n>2, e.g., 3-6) can be prepared in accordance with the procedures described in Lukyanenko et al., J. Chem. Soc. Perkin Trans. 1, pp. 2347-2351 (2002), which is hereby incorporated by reference; S5 (n=1-10) is commercially available; S6 (n=1-2) is commercially available; S6 (n>2, e.g., 3-6) can be prepared in accordance with the procedures described in Dekker et al., ChemBioChem, 3:238-242 (2002) and Svedhem et al., J. Org. Chem., 66:4494-4503 (2001), which are hereby incorporated by reference; L1 is commercially available; L2 can be prepared in accordance with the procedures described in Rastelli et al., Bioorg. Med. Chem. Lett., 13:3257-3260 (2003) and Aronov et al., J. Med. Chem., 41:4790-4799 (1998), which are hereby incorporated by reference; L3 is commercially available; L4 can be prepared in accordance with the procedures described in Kurz et al., Helv. Chim. Acta, 79:1967-1979 (1996), which is hereby incorporated by reference; and L5-L7 are commercially available.

Choice of spacer, linker, and metal chelating group can be based, in part, on the desired length of the tether. For example, spacer, linker, and metal chelating group can be selected such that, when bonded together (e.g., via peptide bonds), the total length of the tether (i.e., the length of the -SP-(LK)ₚ-MCG-moiety) ranges from about D to about 5D (such as from about D to about 4D, from about D to about 3D, from about D to about 2D, from about D to about 1.5D, from about 1.2D to about 5D, from about 1.2D to about 4D, from about 1.2D to about 3D, from about 1.2D to about 2D, from about 1.5D to about 5D, from about 1.5D to about 4D, from about 1.5D to about 3D, and/or from about 1.5D to about 2D), where D represents the binding site-to-target surface site distance (or distances, in cases where q is greater than one and more than one surface site is being targeted). For example, where D is between about 11 and about 14 Å (e.g., between about 11 and about 12 Å or between about 13 and about 14 Å), a tether length of about 14 Å is suitable; where D is between about 11 and about 12 Å, a tether length of from about 12 to about 16 Å (e.g., about 14 Å) is suitable; where D is between about 16 and about 17 Å, a tether length of about 17 Å is suitable; and where D is between about 7 and about 8 Å, a tether length of about 9 Å is suitable.

Other considerations in selecting spacer, linker, and metal chelating groups include the environment in which the modified protein modulator is to be used. For example, in cases where the modified protein modulator is to be used in a hydrophilic environment, spacers which include oxygen atoms may be preferable, for example, to reduce chain folding.

Still other considerations in selecting spacer, linker, and metal chelating groups include the availability of functionalities on each which would readily facilitate spacer-linker and linker-metal chelating group bond formation. In this regard, it will be noted that, although FIG. 1 contemplates the use of peptide bond formation to link the spacer and linker (e.g., by reaction of a COOH group on a spacer with an amine group on a linker or by reaction of an amine group on a spacer with a COOH group on a linker), the use of a nucleophilic substitution reaction to link the linker and the metal chelating group (e.g., by reaction of a secondary amine on a metal chelating group with a bromine-substituted methyl group on a linker), and the use of peptide bond formation to link the linker and the metal chelating group (e.g., by reaction of a COOH group on a linker with an amine group on a metal chelating group), such spacer-linker and linker-metal chelating group linkages should not be viewed as limitative. For example, nucleophilic substitution reactions can be used to link the spacer and the linker (e.g., by reaction of an amine-containing linker with a spacer bearing a bromomethyl group). As further illustration, ester, amide, carbamate, carbonate, urea, and/or enol ether bond formation can be used to effect spacer-linker and/or linker-metal chelating group linkage. Illustrative ester linkages include those represented by the formula —C(O)—O—; illustrative amide linkages include those represented by the formula —C(O)—N(R¹⁰)—; illustrative carbamate linkages include those represented by the formula —N(R¹⁰)—C(O)—O—; illustrative carbonate linkages include those represented by the formula —O—C(O)—O—; illustrative imine linkages include those represented by the formula —C(R¹⁰)═N—; illustrative urea linkages include those represented by the formula —NH—C(O)—NH—; and illustrative enol ether linkages include those represented by the formula ═CR¹⁰—O—; where, in each of the above formulae, R¹⁰ can be hydrogen, substituted or unsubstituted alkyl, or substituted or unsubstituted aryl. Details regarding reaction conditions and starting materials suitable for formation of such linkages can be found in, for example, Morrison et al., Organic Chemistry, 3rd ed., Boston, Mass.: Allyn & Bacon, Inc. (1973) and Kemp et al., Organic Chemistry, New York: Worth Publishers, Inc. (1980), which are hereby incorporated by reference.

As one skilled in the art will appreciate, the present invention has general applicability to a wide variety of enzymes and other proteins. Such enzymes and other proteins can be ones which have been, are, or will be implicated in: animal growth, survival, diseases, or conditions, such as human and other mammalian diseases or conditions (e.g., pathogenic enzymes, carbonic anhydrases, 17-β-hydroxysteroid dehydrogenases, tyrosinases (targets for the treatment of melanoma (e.g., cutaneous melanoma)), reverse transcriptases, cyclooxygenases, adenylate kinases, and aldol reductases); insect growth and/or survival (e.g., proteins modulated by protein modulators having insecticidal activity); and growth and/or survival of agricultural and/or infectious pests (e.g., proteins modulated by protein modulators having pesticidal activity). Other such enzymes and other proteins can be ones which have been, are, or will be implicated in plant growth and survival (e.g., acetolactate and acetohydroxyacid synthases, 5-enolpyruvylshikimate 3-phosphate synthases, acetyl co-enzyme A carboxylases, and other proteins modulated by protein modulators having herbicidal activity). Still other such enzymes and other proteins can be ones which have been, are, or will be implicated in fungus growth and/or survival (e.g., proteins modulated by protein modulators having fungicidal activity). The protein can be a naturally-occurring protein, or it can be a non-naturally-occurring protein. It can be a protein that is produced by site-specific mutagenesis, or it can be one which is not produced by site-specific mutagenesis. The protein can be an acetylcholinesterase, or not. The protein can be one which harbors a surface exposed histidine residue within 10-15 Å of active site pockets, or not.

As one skilled in the art will further appreciate, the present invention has general applicability to a wide variety of protein modulators. Of course, selection of suitable protein modulators depends primarily on the nature of the protein to be modulated and whether protein inhibition or activation is desired.

For example, where inhibition of an aldol reductase is desired, suitable protein modulators which can be used in the practice of the method of the present invention include fidarestats (e.g., fidarestat and other inhibitors based on a fidarestat core) and those based on isoquinoline and benzylisoquinoline alkaloids (such as papaverine and isoboldine). Aldolase reductase is a target for the treatment of diabetes-2.

Where inhibition of a 17-β-hydroxysteroid dehydrogenase is desired, suitable protein modulators which can be used in the practice of the method of the present invention include estradiol inhibitors (e.g., estradiol compounds described in Qiu et al., “A Concerted, Rational Design of Type 1 17-beta-Hydroxysteroid Dehydrogenase Inhibitors: Estradiol-adenosine Hybrids with High Affinity,” FASEB J., 16(13):1829-1831 (2002) and the full text article (FASEB J. (Sep. 5, 2002) 10.1096/fj.02-0026fje, available at http://www.fasebj.org/cgi/doi/10.1096/fj.02-0026fje) (collectively referred to hereinafter as “Qiu”), which are hereby incorporated by reference, and other inhibitors based on an estradiol core), and those described in U.S. Pat. No. 6,541,463 to Labrie et al. and U.S. Pat. No. 6,423,698 to Labrie, which are hereby incorporated by reference. 17-β-Hydroxysteroid dehydrogenase is a target for the treatment of breast cancer.

Where inhibition of an adenylate kinase is desired, suitable protein modulators which can be used in the practice of the method of the present invention include adenosine phosphates, such as P₁,P₅-bis(adenosine)-5′-pentaphosphate and adenosine-5¹-monophosphate. Adenylate kinase is a target for the treatment of neurological disorders.

Where inhibition of a carbonic anhydrase is desired, suitable protein modulators which can be used in the practice of the method of the present invention include sulfonamides, such as benzene sulfonamides and other aryl sulfonamides.

Where inhibition of acetolactate synthase/acetohydroxyacid synthase is desired, suitable protein modulators which can be used in the practice of the method of the present invention include sulfonylureas, such as pyrimidinylsulfonylurea (e.g., amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, oxasulfuron, primisulfuron, pyrazosulfuron, rimsulfuron, sulfometuron, sulfosulfuron, and trifloxysulfuron) and triazinylsulfonylurea herbicides (e.g., chlorsulfuron, cinosulfuron, ethametsulfuron, iodosulfuron, metsulfuron, prosulfuron, thifensulfuron, triasulfuron, tribenuron, triflusulfuron, and tritosulfuron); imidazolinones (e.g., imazamethabenz, imazamox, imazapic, imazapyr, imazaquin, imazethapyr); and triazolopyrimidine sulfonanilides (e.g., flumetsulam and cloransulam).

Where inhibition of 5-enolpyruvylshikimate 3-phosphate synthase (“EPSP synthase”) is desired, suitable protein modulators which can be used in the practice of the method of the present invention include glyphosate and glufosinate.

Where inhibition of acetyl co-enzyme A carboxylases is desired, suitable protein modulators which can be used in the practice of the method of the present invention include aryloxyphenoxypropionates (e.g., chlorazifop, clodinafop, clofop, cyhalofop, diclofop, fenoxaprop-P and other fenoxaprops, fenthiaprop, fluazifop-P and other fluazifops, haloxyfop-P and other haloxyfops, isoxapyrifop, metamifop, propaquizafop, quizalofop-P and other quizalofops, and trifop) and cyclohexadiones (e.g., alloxydim, butroxydim, clethodim, cloproxydim, cycloxydim, profoxydim, sethoxydim, tepraloxydim, and tralkoxydim).

These and other suitable proteins which have been used as targets for controlling plant survival and viability and corresponding herbicidal protein modulators can be found, for example, in Aherns, Herbicidal Handbook, 7th ed., Champaign, Ill.: Weed Society of America (1994); Anderson, Weed Science-Principles and Applications, 3rd ed., New York: West Publishing (1996); Devine et al., Physiology of Herbicide Action, New Jersey: Prentice Hall (1993); and Ross et al., Applied Weed Science, 2nd ed., New Jersey: Prentice Hall (1999), which are hereby incorporated by reference.

As discussed above, the methods of the present invention can be used to enhance a protein modulator's effect on the protein's biological function relative to the protein modulator's effect on other proteins which perform the same biological function and which are modulated by the same protein modulator. Thus, for example, the protein can be an enzyme which is one member of a family of isozymes, and the method of the present invention can be used to enhance an enzyme inhibitor's ability to inhibit enzymatic activity of the one member relative to other members of the isozyme family. Illustratively, the method of the present invention can be used to design modified inhibitors of carbonic anhydrases that are isozyme selective. Such isozyme selective inhibitors of carbonic anhydrases can find a variety of applications in treating several human diseases. As discussed above, the method of the present invention can utilize surface exposed amino acid residues as “anchors” for enhancing the binding affinities of active-site affine inhibitors and other active-site inhibitors. Since there is no selective evolutionary pressure to conserve the surface exposed amino acid residues (particularly among independently functioning proteins), the relative distributions of such amino acid residues are unlikely to be the same among isozymes. This clearly appears to be the case with different isozymes of carbonic anhydrases, and it would not be surprising if this feature were found to be general for other isozyme families as well. Therefore, the method of the present invention can provide an advantage in designing isozyme-specific inhibitors of carbonic anhydrases and other isozyme families. Such a strategy can be used to minimize side effects of non-modified enzyme inhibitors. For example, in the case of the carbonic anhydrases, carbonic anhydrase inhibitors modified in accordance with the method of the present invention can minimize side effects of non-modified carbonic anhydrase inhibitors, such as loss of appetite, increases in frequency of urination, metallic taste in mouth, nausea and vomiting, numbness, and tingling or burning in hands, feet and toes, etc. It should be mentioned that several carbonic anhydrase inhibitors, initially approved for oral administration (for the treatment of glaucoma, epilepsy, and other disorders) were withdrawn due to their side effects, such as, renal stone formation, anorexia, weight loss, malaise, fatigue, depression, loss of libido, etc. Even the topically administered anti-glaucoma drugs (e.g., dorzolamide and brinzolamide) exhibit certain side effects due to their escape into systemic circulation.

The modified protein modulators described hereinabove can be used to modulate the biological activity of the corresponding protein by contacting the protein with the modified protein modulator. Any suitable technique can be used to effect contact between the protein and the modified protein modulator.

For example, in the case where the protein to be modulated is situated in an animal (e.g., an insect, a pest, a mammal, a human, etc.), contact can be effected by administering the modified protein modulator to the animal via any suitable route.

Illustratively, in the case where the animal is a human or other mammal, the modified protein modulators can be made up in any suitable form appropriate for the desired use. Examples of suitable dosage forms include oral, parenteral, and topical dosage forms.

Suitable dosage forms for oral use include tablets, dispersible powders, granules, capsules, suspensions, syrups, and elixirs. Inert diluents and carriers for tablets include, for example, calcium carbonate, sodium carbonate, lactose, and talc. Tablets may also contain granulating and disintegrating agents, such as starch and alginic acid; binding agents, such as starch, gelatin, and acacia; and lubricating agents, such as magnesium stearate, stearic acid, and talc. Tablets may be uncoated or may be coated by known techniques to delay disintegration and absorption. Inert diluents and carriers which may be used in capsules include, for example, calcium carbonate, calcium phosphate, and kaolin. Suspensions, syrups, and elixirs may contain conventional excipients, for example, methyl cellulose, tragacanth, and sodium alginate; wetting agents, such as lecithin and polyoxyethylene stearate; and preservatives, such as ethyl-p-hydroxybenzoate. Dosage forms for oral administration can also be formulated as food preparations using materials which are conventionally used in the food processing industry, such as proteins, sugars and other carbohydrates, extenders, fillers, preservatives, and the like.

Dosage forms suitable for parenteral administration include solutions, suspensions, dispersions, emulsions, and the like. They may also be manufactured in the form of sterile solid compositions which can be dissolved or suspended in sterile injectable medium immediately before use. They may contain suspending or dispersing agents known in the art. Examples of parenteral administration are intraventricular, intracerebral, intramuscular, intravenous, intraperitoneal, rectal, and subcutaneous administration.

Suitable topical dosage forms include gels, creams, lotions, ointments, powders, aerosols and other conventional forms suitable for direct application of medicaments to skin or mucous membranes. Topical ointments, pastes, creams, and gels can include, in addition to the active MM soft tissues and/or extracts thereof, customary excipients, for example animal and vegetable fats, waxes, paraffins, starch, tragacanth, cellulose derivatives, polyethylene glycols, silicones, bentonites, silicic acid, talc, and zinc oxide, or mixtures of these substances. Topical powders and sprays can include, in addition to the modified protein modulators, the customary excipients, for example lactose, talc, silicic acid, aluminum hydroxide, calcium silicate and polyamide powder, or mixtures of these substances. Sprays can additionally contain the conventional propellants, such as chlorofluorohydrocarbons.

It will be appreciated that the actual preferred amount of modified protein modulators to be administered according to the present invention will vary according to the particular modified protein modulators being used, the particular composition formulated, and the mode of administration. Many factors that may modify the action of the modified protein modulators (e.g., body weight, sex, diet, time of administration, route of administration, rate of excretion, condition of the subject, drug combinations, and reaction sensitivities and severities) can be taken into account by those skilled in the art.

Administration of the modified protein modulators can be carried out continuously or periodically within the maximum tolerated dose. Optimal administration rates for a given set of conditions can be ascertained by those skilled in the art using conventional dosage administration tests.

In cases where the animal is a insect or other pest, the modified protein modulators can be administered to the animal by contacting the insect or other pest's external surface with the modified protein modulators, for example, by use of a spray or powder. Such sprays or powders can be formulated using conventional carriers, and they can be applied once or repeatedly (e.g., once a week) to an area where the insect or other pest is known or believed to exist. Alternatively, modified protein modulators, optionally formulated into a spray or powder, can be applied to vegetation on which the insect or other pest is known or believed to feed.

In the case where the protein to be modulated is situated in an plant (e.g., a weed or other undesirable plant), contact can be effected by applying the modified protein modulators, optionally formulated into a spray or powder, to one or more parts of the plant, such as to the stems, leaves, and/or flowers of the plant. Alternatively, the modified protein modulators, optionally formulated into a spray, powder, or liquid solution or dispersion can be applied to the ground in which the plants are growing. It will be appreciated that the actual preferred amount of modified protein modulators to be applied will vary according to the particular modified protein modulators being used, the particular composition formulated, and the mode of administration. Many factors that may modify the action of the modified protein modulators (e.g., time of administration, route of administration, and/or rate of modified protein modulator decomposition) can be taken into account by those skilled in the art in optimizing application conditions.

The present invention, in another aspect thereof, relates to a modified protein modulator having the formula:
PM-SP-(LK)ₚ-MCG-(M)_{q}
where PM is a protein modulator which interacts with an active site or allosteric site of a protein; SP is a spacer; LK is a linker; p is 0 or 1; q is an integer greater than or equal to one; MCG is a metal chelating group; and M is a metal ion. For example, PM, SP, LK, p, q, MCG, and M can be selected from the illustrative examples provided hereinabove with regard to the methods for making such modified protein modulators. In one illustrative embodiment, PM is an acetolactate synthase inhibitor, such as a sulfonylurea acetolactate synthase inhibitor (e.g., a chlorimuron acetolactate synthase inhibitor or other pyrimidinylsulfonylurea acetolactate synthase inhibitor). In another illustrative embodiment, -SP-(LK)ₚ-MCG-, taken together, represents a tether having a length of from about 8 to about 20 Å. In yet another illustrative embodiment, PM is an acetolactate synthase inhibitor, and -SP-(LK)ₚ-MCG-, taken together, represents a tether having a length of from about 12 to about 16 Å (e.g., about 14 Å).

Certain aspects of the present invention are further illustrated with the following examples. The examples also illustrate various applications in which the fluxional chiral ligands of the present invention can be used.

### EXAMPLES

### Example 1

### Modified Inhibitors of Carbonic Anhydrase

Inhibition of carbonic anhydrase is important for the treatment of glaucoma and cancer. Usually, the clinically approved inhibitors are the sulfonamide class of compounds. Conjugation of the high-affinity sulfonamides with bile acids, short peptides, amino-polycarboxylate ligands and their metal complexes further enhances inhibition efficiency.

In this Example 1, we report a strategy to convert a poor inhibitor to a good inhibitor by attaching a surface-histidine recognition group to the inhibitor. Benzene sulfonamide, a rather weak inhibitor for carbonic anhydrase (K_{d}=120 μM), was converted to a very good inhibitor for the enzyme (K_{d}=130 nM) as a result of this conjugation.

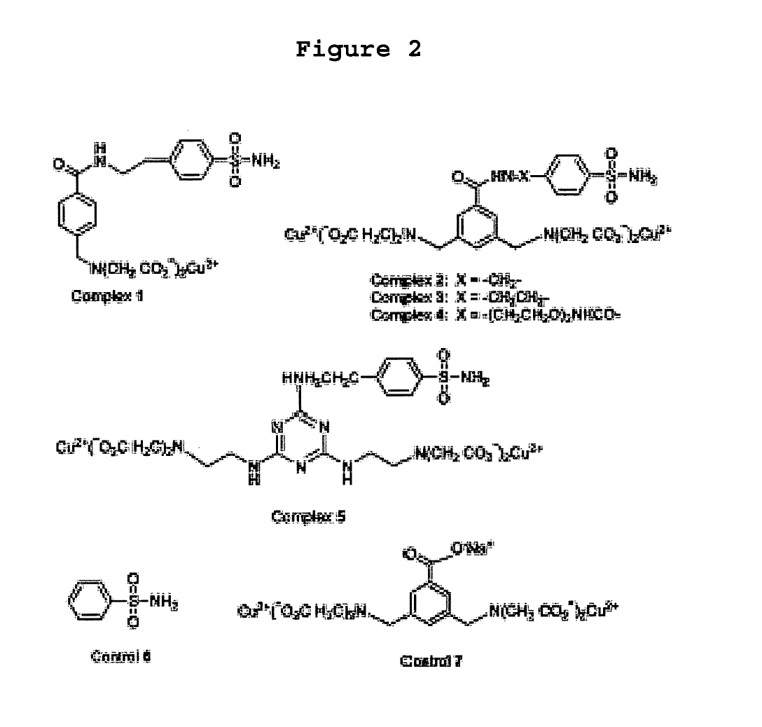

To demonstrate the proof-of-concept, five Cu²⁺-complexes set forth in FIG. 2 were designed and synthesized. The synthetic details for these five complexes are set forth hereinbelow in Example 2. In these complexes, the benzene sulfonamide binds to the active-site Zn²⁺ ion of the enzyme. It was estimated by molecular modeling (BioMed CAChe 6.0, Fujitsu America, Beaverton, Oreg.) that the Cu²⁺ ions of the complexes are then capable of binding to His-4 or His-17 on the surface of carbonic anhydrase (bovine erythrocyte, protein data bank file: 1g6v.pdb). The targeted histidine residues are close to the N-terminus of the enzyme. The protein backbone in this region is flexible and has a random coil structure, facilitating the binding of the cupric ions to the histidines when the benzene sulfonamide is bound to the Zn²⁺ ion in the active site.

There are literature reports (Blasie et al., Biochemistry, 41:15068ff (2002); DeGrado et al., Angew. Chem., Int. Ed., 42:417ff (2003); and Tian et al., J. Am. Chem. Soc., 118:943ff (1996), which are hereby incorporated by reference) of flexible peptides converted to rigid structures by coordination to transition metal ions (Cu²⁺, Zn²⁺). These rigid peptides demonstrated enhanced biological properties (including improved inhibition of the enzyme alpha-amylase) compared to the flexible counterparts. However, in these reported examples, the enhancement of biological properties is due to the rigidity of the structures induced by the metal ions.

For the studies reported herein, the ligand iminodiacetic acid (“IDA”) was used to chelate the cupric ions (K=10¹² M⁻¹). The length of the spacer separating the benzene sulfonamide group from IDA was varied in these complexes. Benzene sulfonamide (6) and the di-Cu²⁺ complex 7 (lacking the benzene sulfonamide moiety) were used as controls for these studies.

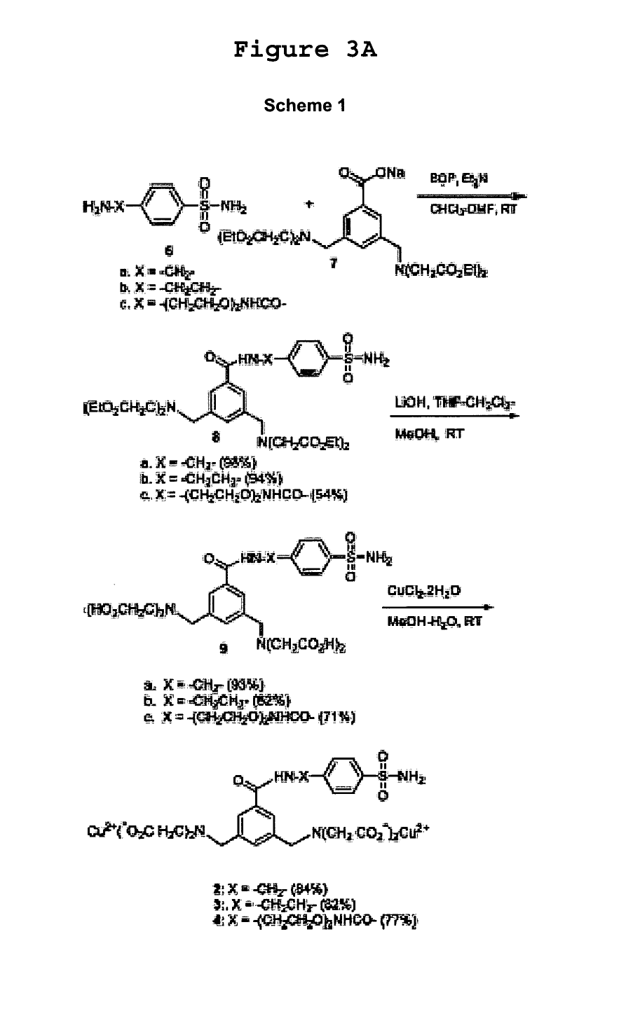

The syntheses of sulfonamide-based metal complexes 2, 3, and 4 are depicted in FIG. 3A (Scheme 1), and the syntheses of sulfonamide-based metal complexes 1 and 5 are depicted in FIG. 3B (Schemes 2, 3, and 4). Briefly, the reported Na-salt of IDA (7) (prepared in accordance with the method described in Roy et al., J. Org. Chem., 64:2969-2974 (1999), which is hereby incorporated by reference) was coupled with the sulfonamides (6) using BOP reagent (benzotriazol-1-yloxytris(dimethylamino)-phosphonium hexafluorophosphate). The synthesis of complex 5 was carried out by reacting cyanuric chloride and 2 equivalents of amine-IDA ester (Sun et al., Org. Lett., 2:911-914 (2000), which is hereby incorporated by reference). It was then combined with 4-(aminoethyl)benzene sulfonamide. Further details regarding the syntheses of complexes 1-5 are presented in Example 2.

Complexes 2, 3, and 4 have two cupric ions about 8 Å apart (Shirai et al., J. Org. Chem., 55:2767-2770 (1990), which is hereby incorporated by reference). Complex 5 is flexible, and the distances between the Cu²⁺ ions was estimated to be 8-12 Å (employing BioMed CAChe, version 6.0).

The binding constants of these complexes with carbonic anhydrase (bovine erythrocyte, Sigma Chemical Company, mixture of isozymes) were determined employing isothermal titration calorimetry (25 mM HEPES buffer, pH=7.0), and the results are presented in Table 1.

TABLE 1

| Compound | Binding constant | Enthalpy (kcal/mol) |
|---|---|---|
| Complex 1 | (4.6 ± 0.07) × 10⁶ | −26.4 ± 0.8 |
| Complex 2 | (1.9 ± 0.03) × 10⁵ | −51.7 ± 5.8 |
| Complex 3 | (7.5 ± 0.1) × 10⁶ | −36.9 ± 4.2 |
| Complex 4 | (5.4 ± 0.02) × 10⁵ | −30.3 ± 2.6 |
| Complex 5 | (4.3 ± 0.03) × 10⁵ | −45.5 ± 2.2 |
| Control 6 | (9.0 ± 0.1) × 10³ | −31.2 ± 1.6 |
| Control 7 | (22.8 ± 1.3) × 10³ | −129.0 ± 3.2 |

The two controls, benzene sulfonamide (control 6) and the di-IDA-Cu²⁺ complex 7 (lacking the benzene sulfonamide group) showed weak affinity for the enzyme. Affinities of the conjugates were considerably higher compared to the controls. Complex 3 showed the highest affinity for the enzyme, three orders of magnitude higher compared to the controls. The similarity of binding constants for complexes 1 (one Cu²⁺ ion) and 3 (two Cu²⁺ ions) possibly indicates that one cupric ion is binding to one histidine on the surface of the protein. Since the enzyme preparation included a mixture of isozymes, it is possible that different histidine residues from different isozymes contribute to this binding.

In order to demonstrate the binding of histidine residues to the cupric ions, the free ligands for these complexes (i.e., 9a, 9b, and 9c, prepared as shown in FIG. 3A) were titrated with the enzyme. The affinities were found to be much lower, similar to those of the controls 6 and 7. In addition, the Cu²⁺ complexes were titrated with the enzyme employing UV-Vis spectrometry (Fazal et al., J. Am. Chem. Soc., 123:6283ff (2001) (“Fazal”), which is hereby incorporated by reference). The absorbance maxima for the cupric complexes were found to shift from 735 nm to 666 nm upon sequential addition of carbonic anhydrase, indicating the coordination of histidines to the cupric ions (Fazal, which is hereby incorporated by reference). The kinetic parameters (Kₘ, Vₘₐₓ, and Kᵢ) of the carbonic anhydrase catalyzed reactions were determined by measuring the hydrolysis of p-nitrophenyl acetate at 450 nm, and the results are presented in Table 2.

TABLE 2

| Inhibitor | Kₘ/μM) | Vₘₐₓ (ΔA₄₅₀)/min⁻¹ | Kᵢ/μM |
|---|---|---|---|
| no inhibitor | 15.70 | 0.31 | |
| Complex 2 | 28.30 | 0.25 | 0.74 |
| Complex 3 | 36.10 | 0.33 | 0.124 |
| Complex 4 | 29.20 | 0.31 | 0.814 |

The substrate concentration dependent kinetic data in the absence and presence of inhibitors were analyzed by the non-linear regression analysis program, Grafit 4.0, and visualized in the form of the double reciprocal plots. The analyses of the kinetic data conformed to the competitive inhibition model, and excluded other (viz., non-competitive and uncompetitive) models. It should be noted that the Kᵢ values determined by the kinetic method are similar to the dissociation constants (K_{d}=1/Kₐ) of the corresponding enzyme-inhibitor complexes (see, for example, Table 1), determined via the isothermal titration microcalorimetric method.

In conclusion, this Example 1 demonstrates that the conjugation of a poor inhibitor (for the enzyme carbonic anhydrase) with a surface-binding functionality enhances the inhibitor efficiency by three orders of magnitude.

Further experimental details and UV-Vis titration data regarding the experiments described in this Example 1 can be found in the following Example 2 and in Roy et al., “Conjugation of Poor Inhibitors with Surface Binding Groups: A Strategy to Improve Inhibition,” Chem. Commun., 2328-2329 (2003) and the associated electronic supplemental information (available at http://www.rsc.org/suppdata/cc/b3/b305179j/), which are hereby incorporated by reference.

### Example 2

### Details Regarding the Preparation and Characterization of Modified Inhibitors of Carbonic Anhydrase

This example described further details regarding the syntheses of complexes 1-5 as depicted in FIGS. 3A and 3B (Schemes 1-4).

Compound 12 was prepared as follows. Br-^{t}But ester 11 (Shirai et al., J. Org. Chem., 55:2767-2770 (1990), which is hereby incorporated by reference ) (7.73 g, 28.54 mmol), diethyliminodiacetate (4.50 g, 23.78 mmol), and K₂CO₃ (12.0 g, 85.7 mmol) were mixed together in CH₃CN. The resultant mixture was refluxed for 12 h. Solid was filtered and washed with CH₃CN. The solvent was removed in vacuo. The crude product was purified by silica gel column chromatography with 20% ethyl acetate in hexane (R_{f}=0.6) to afford a viscous liquid. Yield: 7.0 g (77%). ¹H NMR (300 MHz, CDCl₃) δ 1.31 (t, 6H, J=7.0 Hz), 1.64 (s, 9H), 3.58 (s, 4H), 4.02 (s, 2H), 4.21 (q, 4H, J=7.0 Hz), 7.49 (d, 2H, J=8.0 Hz), 7.80 (d, 2H, J=8.0 Hz).

The resultant ester (4.80 g, 12.66 mmol) was dissolved in CH₂Cl₂ (20 mL), and ice-cold TFA (20 mL) was added. It was stirred at room temperature for 5 h. The excess TFA was removed in vacuo, and it was again dissolved in CH₂Cl₂ and washed with ice-cold NaHCO₃ solution. It was dried over Na₂SO₄. The solvent was removed in vacuo to obtain a white solid. Yield: 3.65 g (83%). ¹H NMR (300 MHz, CDCl₃) δ 1.32 (t, 6H, J=7.0 Hz), 3.60 (s, 4H), 4.05 (s, 2H), 4.21 (q, 4H, J=7.0 Hz), 7.56 (d, 2H, J=8.0 Hz), 8.11 (d, 2H, J=8.0 Hz)

Complex 1 was prepared as follows. The Na-salt of acid 12 (0.80 g, 2.32 mmol) and 4-(aminoethyl) benzenesulfonamide hydrochloride 6b (0.465 g, 2.32 mmol) were then coupled with BOP reagent (1.03 g, 2.32 mmol) and Et₃N (0.65 mL, 4.67 mmol) in CHCl₃/DMF (10/5 mL). The reaction was allowed to continue at room temperature for 10 h. The reaction was quenched with saturated brine solution. The organic solvent was removed in vacuo, and the compound was precipitated as a white solid in water. It was filtered and washed with water. Yield: 1.1 g (94%), mp: 110-112° C. ¹H NMR (300 MHz, CDCl₃) δ 1.30 (t, 6H, J=7.0 Hz), 3.03 (t, 2H, J=7.0 Hz), 3.21 (bs, 2H), 3.54 (s, 4H), 3.64 (q, 2H, J=7.0 Hz), 3.97 (s, 2H), 4.20 (q, 4H, J=7.0 Hz), 7.04 (bs, 1H), 7.38 (d, 2H, J=8.0 Hz), 7.46 (d, 2H, J=8.5 Hz), 7.82-7.88 (m, 4H).

The ester (0.40 g, 0.79 mmol) was dissolved in CH₂Cl₂/MeOH (6/6 mL), and solid LiOH (0.11 g, 2.62 mmol) was added. The reaction mixture was stirred at room temperature for 15 h. The solution was acidified by concentrated HCl to pH=3.0. The white solid was filtered and washed with MeOH/CH₂Cl₂ (40/60) to provide 255 mg of acid (72%). ¹H NMR (300 MHz, D₂O) δ 2.98 (t, 2H, J=6.5 Hz), 3.65 (t, 2H, J=6.5 Hz), 3.85 (s, 4H), 4.48 (s, 2H), 7.44 (d, 2H, J=8.5 Hz), 7.52 (d, 2H, J=8.5 Hz), 7.60 (d, 2H, J=8.0 Hz), 7.78 (d, 2H, J=8.0 Hz). ¹³C NMR (100 MHz, D₂O) δ 25.71, 32.05, 48.42, 49.07, 116.39, 118.18, 120.59, 121.39, 123.97, 132.73, 133.74, 135.77, 161.94, 170.60.

The acid (0.15 g, 0.30 mmol) was dissolved in MeOH/H₂O (5/2 mL), and CuCl₂.2H₂O (52.5 mg, 0.30 mmol) was added in MeOH (5 mL). The reaction mixture was stirred at room temperature for 6 h. The precipitated solid was filtered and washed with MeOH to afford 120 mg (70%) of complex 1 as a blue solid. Anal. Calcd. for C₂₀H₂₁CuN₃O₇S: C, 46.79; H, 4.11; N, 8.21. Found: C, 46.64; H, 4.11; N, 8.18.

Compound 8a was prepared as follows. The Na-salt of acid 7 (0.60 g, 1.1 mmol) was coupled with 4-(aminomethyl)benzene sulfonamide hydrochloride 6a (0.225 g, 1.1 mmol) in presence of BOP reagent (0.49 g, 1.1 mmol) and Et₃N (0.3 mL, 2.15 mmol) in CHCl₃/DMF (20/5 mL). The reaction was carried out at room temperature for 12 h. The work up procedure was the same as described for complex 1 (BOP coupling). Yield: 0.76 g (98%); mp: 126-128° C. ¹H NMR (300 MHz, CDCl₃) δ 1.26 (t, 12H, J=7.0 Hz), 3.54 (s, 8H), 3.94 (s, 4H), 4.11-4.22 (m, 8H), 4.65 (d, 2H, J=6.0 Hz), 5.20 (bs, 2H), 5.73 (bs, 1H), 7.41 (d, 2H, J=8.0 Hz), 7.53 (s, 1H), 7.79 (d, 2H, J=8.0 Hz), 7.88 (s, 2H).

Compound 9a was prepared as follows. The saponification of ester 8a (0.34 g, 0.487 mmol) was achieved with LiOH (140 mg, 3.33 mmol) in THF/CH₂Cl₂/MeOH (4/4/4 mL) at room temperature for 12 h. The pH of the solution was adjusted to 3.0 by adding concentrated HCl. The white solid was filtered and washed with absolute ethanol. Yield: 320 mg (93%). ¹H NMR (300 MHz, D₂O) δ 3.43 (s, 8H), 4.12 (s, 4H), 4.66 (s, 2H), 7.56 (d, 2H, J=8.5 Hz), 7.67 (s, 1H), 7.83-7.89 (m, 4H). ¹³C NMR (125 MHz, D₂O) δ 45.95, 51.69, 60.07, 60.66, 129.01, 130.69, 132.19, 137.00, 138.88, 142.75, 146.40, 172.79.

Complex 2 was prepared as follows. The acid 9a (150 mg, 0.25 mmol) was dissolved in MeOH/H₂O (5/2 mL), and CuCl₂.2H₂O (90 mg, 0.53 mmol) was added. It was stirred at room temperature for 8 h. Solvents were removed in vacuo, and the solid was triturated with absolute ethanol. The precipitate was filtered and washed with ethanol. Yield: 180 mg (93%). Anal. Calcd. for C₂₄H₂₆Cu₂N₄O₁₁S.2HCl. 4H₂O: C, 33.94; H, 4.00; N, 6.60. Found: C, 34.02, H, 3.91; N, 6.53.

Compound 8b was prepared as follows. The coupling of acid 6 (0.70 g, 1.28 mmol) and 4-(aminoethyl)benzene sulfonamide hydrochloride 6b (0.26 g, 1.28 mmol) was carried out with BOP reagent (0.57 g, 1.28 mmol) and Et₃N (0.5 mL, 3.6 mmol) in CHCl₃/DMF (20/5 mL). The work up procedure was the same as described for Complex 1 (BOP coupling). The crude product was purified by silica gel column chromatography with 8% MeOH in CHCl₃ (R_{f}=0.4) to afford a viscous liquid. Yield: 0.85 g (94%). ¹H NMR (300 MHz, CDCl₃) δ 1.28 (t, 12H, J=7.0 Hz), 2.98-3.04 (m, 2H), 3.51 (s, 8H), 3.70 (d, 2H, J=6.5 Hz), 3.91 (s, 4H), 4.10-4.21 (m, 8H), 5.44 (bs, 2H), 6.00 (t, 1H, J=6.0 Hz, NH), 7.38 (d, 2H, J=8.5 Hz), 7.49 (s, 1H), 7.72 (s, 2H), 7.88 (d, 2H, J=8.5 Hz).

Compound 9b was prepared as follows. The ester 8b (0.49 g, 0.695 mmol) was hydrolyzed by LiOH (0.11 g, 4.52 mmol) in THF-CH₂Cl₂—MeOH (4/4/8 mL) at room temperature for 10 h. The work up procedure was the same as described for compound 9a. Yield: 0.34 g (82%). ¹H NMR (300 MHz, D₂O) δ 2.98 (t, 2H, J=6.2 Hz), 3.62-3.70 (m, 2H), 3.82 (s, 8H), 4.50 (s, 4H), 7.45 (d, 2H, J=8.0 Hz), 7.74-7.81 (m, 5H). ¹³C NMR (125 MHz, D₂O) δ 27.74, 37.31, 43.44, 58.97, 60.84, 70.57, 128.74, 132.74, 133.59, 134.03, 138.66, 139.74, 141.97, 147.84, 171.52, 172.53. Anal. Calcd. for C₂₅H₃₀N₄O₁₁S.2HCl.H₂O: C, 43.75; H, 4.96; N, 8.17. Found: C, 43.42; H, 5.09; N, 8.12.

Complex 3 was prepared by dissolving acid 9b (0.15 g, 0.252 mmol) in MeOH/H₂O (4/2 mL), followed by the addition of CuCl₂.2H₂O (86 mg, 0.504 mmol). The same work up procedure was followed as described for complex 1.

Yield: 170 mg (82%). Anal. Calcd. for C₂₅H₂₆Cu₂N₄O₁₁S. 2HCl.2H₂O: C, 36.33; H, 3.90; N, 6.78. Found: C, 36.23; H, 4.05; N, 6.72.

Compound 6c was prepared as follows. 4-Carboxybenzenesulfonamide (2.00 g, 9.94 mmol) was dissolved in CH₂Cl₂ (50 mL) in presence of Et₃N (4.1 mL, 29.47 mmol), followed by the addition of amine 14 (Roy et al., J. Org. Chem., 64:2969-2974 (1999), which is hereby incorporated by reference) (2.46 g, 9.94 mmol) in CH₂Cl₂ (10 mL) and BOP reagent (4.40 g, 9.94 mmol). Stirring was continued for 12 h at room temperature. The reaction was quenched with saturated NaCl solution, and solvent was removed in vacuo. The compound was extracted by ethyl acetate, and the organic layer was washed with water. Purification was achieved by silica gel column chromatography with 15% MeOH in CHCl₃ (R_{f}=0.5) to afford white solid. Yield: 2.89 g (65%). Mp: 131-132° C. ¹H NMR (300 MHz, CDCl₃) δ 1.45 (s, 9H), 2.26 (bs, 2H), 3.20-3.24 (m, 2H), 3.30-3.36 (m, 2H), 3.48-3.58 (m, 2H), 3.60-3.70 (m, 6H), 5.09 (bs, 1H), 5.99 (bs, 1H), 7.86 (m, 4H).

The amine-Boc compound (3.0 g, 6.95 mmol) was dissolved in dry CH₂Cl₂ (20 mL), and cold TFA (15 mL) was added. It was stirred at room temperature for 3 h. The excess TFA was removed in vacuo to afford viscous liquid 2.85 g (92%). ¹H NMR (400 MHz, D₂O) 3.11 (t, 2H, J=4.8 Hz), 3.56 (t, 2H, J=5.4 Hz), 3.60-3.72 (m, 8H), 7.83-7.87 (m, 2H), 7.90-7.95 (m, 2H).

Compound 8c was prepared as follows. The Na-salt of acid 7 (0.50 g, 0.915 mmol) was coupled with amine-TFA 6c (0.57 g, 1.72 mmol) with HBTU (0.35 g, 0.923 mmol), HOBT (0.125 g, 0.925 mmol), and Et₃N (0.7 mL, 5.03 mmol) in DMF (20 mL). The reaction mixture was stirred at room temperature for 10 h. The work up procedure was the same as described for 6c (amine-Boc). The crude product was purified by silica gel column chromatography with 10% MeOH in CHCl₃ (R_{f}=0.4) to obtain a viscous liquid (0.45 g, 54%). ¹H NMR (500 MHz, CDCl₃) δ 1.27 (t, 12H, J=7.1 Hz), 3.50-3.55 (m, 10H), 3.65-3.75 (m, 10H), 3.89 (s, 4H), 4.17 (q, 8H, J=7.1 Hz), 6.02 (bs, 2H), 7.21 (bs, 1H), 7.38 (bs, 1H), 7.43 (s, 1H), 7.75 (s, 2H), 7.82 (m, 4H).

Compound 9c was prepared as follows. The ester 8c (0.18 g, 0.195 mmol) was hydrolyzed by LiOH (50 mg, 1.19 mmol) in THF-MeOH (4/8 mL) at room temperature for 8 h. The work up procedure was the same as described for compound 9a. Yield (white solid): 130 mg (82%). ¹H NMR (400 MHz, D₂O) δ 3.59 (s, 4H), 3.70-3.78 (m, 8H), 3.98 (s, 8H), 4.57 (s, 4H), 7.82-7.88 (m, 3H), 7.90-7.96 (m, 4H). ¹³C NMR (100 MHz, D₂O) δ 30.94, 47.05, 49.54, 59.95, 60.02, 60.80, 117.48, 119.44, 121.91, 123.04, 126.87, 128.65, 128.99, 135.35, 159.89, 160.40, 160.67.

Complex 4 was prepared as follows. The acid 9c (70 mg, 0.087 mmol) was combined with CuCl₂.2H₂O (30 mg, 0.175 mmol) in MeOH/H₂O(4/6 mL) at room temperature. The rest of the procedure was the same as described for complex 1. Yield: 48 mg (57%). Anal Calcd. for C₃₀H₃₅Cu₂N₅O₁₄S.2HCl.2H₂O: C, 37.72; H, 4.31; N, 7.31. Found: 38.02; H, 4.45; N, 7.35.

Compound 17 was prepared as follows. Cyanuric chloride (2.00 g, 6.55 mmol) was dissolved in THF (20 mL), followed by the addition of DIEA (6.8 mL, 39.11 mmol) and amine-2HCl salt 16 (Sun et al., Org. Lett., 2:911-914 (2000), which is hereby incorporated by reference) (1.17 g, 6.34 mmol) in THF (10 mL). The stirring was continued for another 8 h at room temperature. The product was extracted with CH₂Cl₂, and the organic layer was washed with water. The pure product was obtained by silica gel column chromatography with 4% MeOH in CHCl₃ (R_{f}=0.7) as a reddish viscous oil.

Yield: 1.70 g (90%). ¹H NMR (300 MHz, CDCl₃) δ 1.27 (t, 12H, J=7.0 Hz), 2.95-2.98 (m, 4H), 3.41-3.48 (m, 4H), 3.54 (s, 8H), 4.15-4.22 (q, 8H, J=7.0 Hz), 7.68 (bs, 2H). ¹³C NMR (125 MHz, CDCl₃) δ 14.42, 39.55, 51.99, 55.29, 61.27, 165.66, 169.96, 170.80, 171.81.

The ester (0.31 g, 0.533 mmol) and 4-(aminoethyl)benzene sulfonamide hydrochloride 6b (0.106 g, 0.533 mmol) and DIEA (0.20 mL, 1.15 mmol) were mixed in 1,4-dioxane (10 mL) and was warmed in a sealed tube at 110° C. for 48 h. After cooling to room temperature, the solvent was removed, and product was purified by silica gel column chromatography with 6% MeOH in CHCl₃ (R_{f}=0.3). Yield: 330 mg (83%). ¹H NMR (300 MHz, CDCl₃) δ 1.29 (m, 12H), 2.88-2.92 (bs, 2H), 2.95-2.99 (m, 4H), 3.32-3.44 (m, 4H), 3.60 (s, 8H), 3.69-3.78 (m, 4H), 4.18-4.24 (m, 8H), 5.60 (bs, 2H), 6.76 (bs, 1H), 7.34 (t, 2H, J=8.0), 7.72-7.78 (m, 2H).

Complex 5 was prepared as follows. The ester 17 (0.15 g, 0.20 mmol) was hydrolyzed with LiOH (56 mg, 1.3 mmol) in MeOH/THF (4/4 mL). The reaction mixture was stirred at room temperature for 15 h. The work up procedure was the same as described for 9a. Yield: 120 mg (70%). ¹H NMR (400 MHz, D₂O) δ 2.98-3.03 (m, 4H), 3.40-3.45 (m, 4H), 3.66-3.70 (m, 4H), 3.85 (s, 8H), 7.50 (d, 2H, J=8.0 Hz), 7.82 (d, 2H, J=8.0 Hz).

The metal complex 5 was prepared by dissolving the above acid (70 mg, 0.11 mmol) and CuCl₂.2H₂O (40 mg, 0.23 mmol) in MeOH (5 mL). It was stirred at room temperature for 8 h. The same work up procedure was followed as described for complex 1. Yield: 70 mg (77%). Anal. Calcd. for C₂₃H₂₉Cu₂N₉O₁₀S.3HCl.2H₂O: C, 30.83; H, 4.05; N, 14.07. Found: C, 30.65; H, 3.88; N, 13.85.

The titration procedures employing isothermal titration calorimetry were carried out employing the instrument ITC-4200 (Calscorp Inc., Provo, Utah). The reference cell (volume: 1.32 mL) was filled with 25 mM HEPES buffer, pH=7.0. Carbonic anhydrase was taken in the sample cell (1.32 mL, 100 mM protein in 25 mM HEPES buffer, pH=7.0). The copper complexes (1 mM) were dissolved in the same buffer and were added to the enzyme solution (42×5 μL injections). Heats of dilution for the complexes were separately determined by injecting the solution of the complexes in buffer (taken in the sample cell). The heats of dilution were subtracted from the titration data files, and the resultant data were processed by the software provided by the manufacturer (Bind Works 3.0). Each titration was repeated at least three times and the average of the three are shown in Example 1

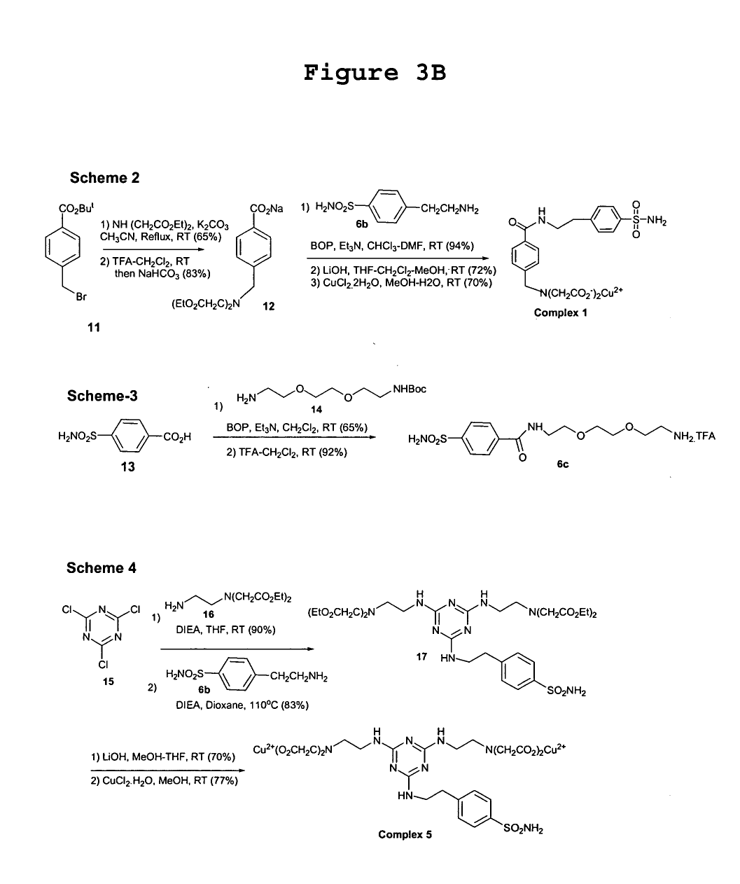

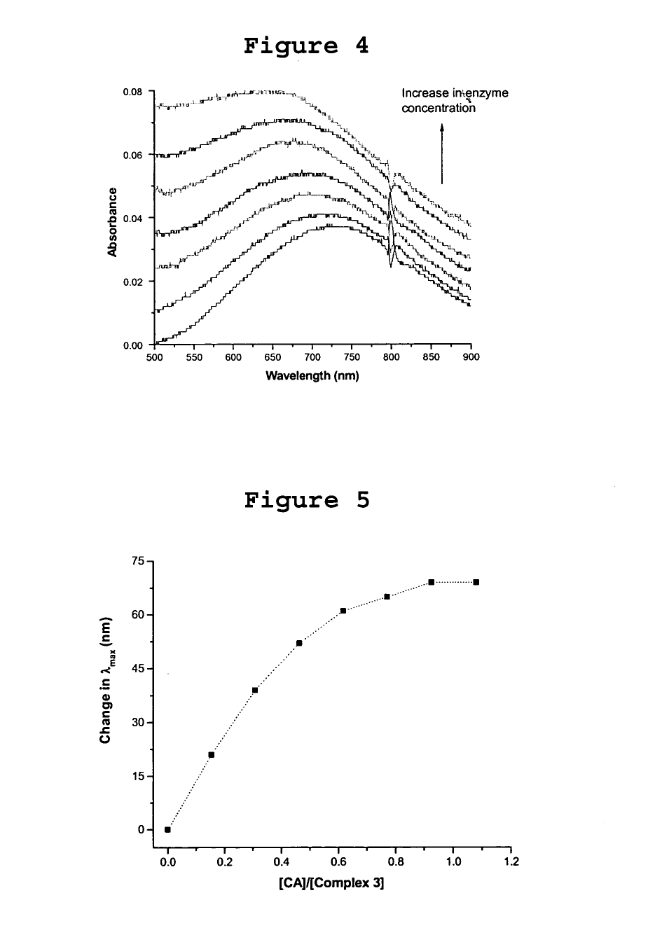

Titration of complex 3 with carbonic anhydrase employing UV-Vis spectrometry is described below. A solution of complex 3 (250 μM, 1 mL) in 25 mM HEPES buffer (pH=7.0) was taken in the cuvet, and 20 μL portions of a solution of the enzyme (750 μM in 25 mM HEPES buffer, pH=7.0) was added to this solution (temperature: 24° C.). The absorbance maximum was found to shift upon addition of the enzyme to the complex, as shown in FIGS. 4 and 5. With regard to FIG. 5, note that the dotted line connecting the data points is not a fitted curve.

The inhibition experiments described in Example 1 were carried out as follows.

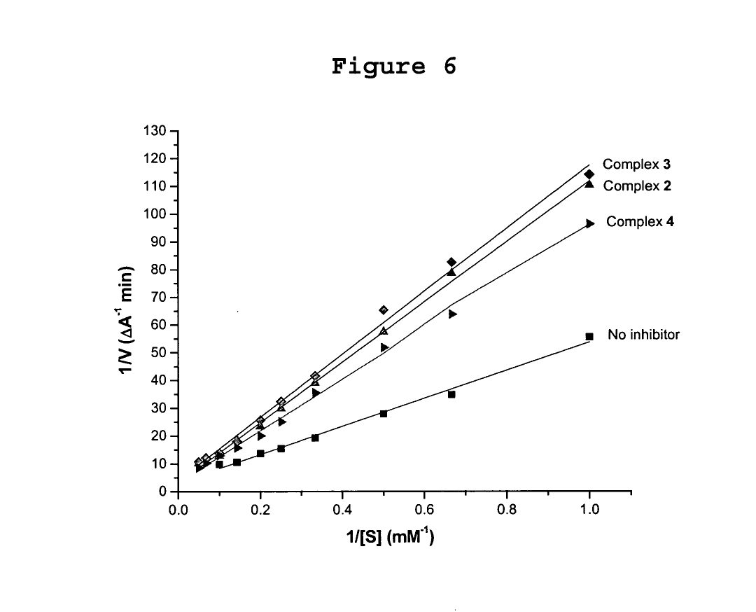

For determining the Kᵢ values of complexes 2-4, the concentrations of different compounds required to achieve about 50% inhibition of the enzyme (2.5 μM) in the presence of 75 μM substrate (p-nitrophenyl acetate) were first determined (25 mM HEPES buffer, pH=7.0; absorbance followed at 450 nm). The kinetic data were analyzed via the double reciprocal plots of the initial rates of the enzyme catalyses and the substrate concentrations in the presence of different concentrations of inhibitors. Illustrative double reciprocal plots are set forth in FIG. 6. Note that, in FIG. 6, the straight lines represent fitted lines through the data points and that, for clarity, data points in FIG. 6 are shown only for selected concentrations of inhibitors. The double reciprocal plots revealed that all inhibitors (complexes 2-4) were competitive types. However, since the concentration of the enzyme utilized during the above experiments was comparable to those of different inhibitors, the free concentrations of inhibitors were calculated via the complete solution of the quadratic equation describing the enzyme-inhibitor interaction. For such calculations, the association constants of the individual enzyme-inhibitor complexes (determined via the isothermal titration microcalorimetry) were taken into account.

The enzyme activity was measured in a 25 mM HEPES buffer, pH 7.0, by addition of an appropriately diluted enzyme (2.5 μM) to the substrate solution (prepared in 15% acetonitrile), followed by measuring the increase in absorption at 450 nm. The initial (steady-state) rates of the enzyme catalyzed reaction as a function of substrate concentration were analyzed according to the Michaelis-Menten equation to obtain the Kₘ and Vₘₐₓ values. The Kᵢ values of the enzyme-inhibitor complexes were determined according the following relationship: Kᵢ=[I]/(Kₚ/K−1), where Kₚ and Kₘ represent Michaelis constants in the absence and presence of inhibitor.

All the inhibition data were analyzed according to the non-linear regression analysis package Grafit 4.0 (of Dr. Leatherbarrow, who initially wrote the widely utilized steady-state kinetic software package, “Enzfitter”), and presented the data in the form of the double reciprocal plots. The analyses of the data exclusively conformed to the competitive type of inhibition model. As can be visually seen from the data of FIG. 6, the Kₘ value in the presence of inhibitor is much higher than in its absence (eliminating the possibility of “uncompetitive inhibition”), and the Vₘₐₓ value remains unchanged (eliminating the possibility of “non-competitive inhibition”). Admittedly, due to solubility problems, we could not perform the inhibition studies at higher inhibitor concentrations to show the intersecting patterns at the Y-Axis for each inhibitor. However, since the Kᵢ values derived from the inhibition studies are similar to the corresponding dissociation constants of the enzyme-inhibitor complexes, it attests to the internal consistency of our competitive inhibition model.

### Example 3

### Modified Inhibitors of Aldol Reductase

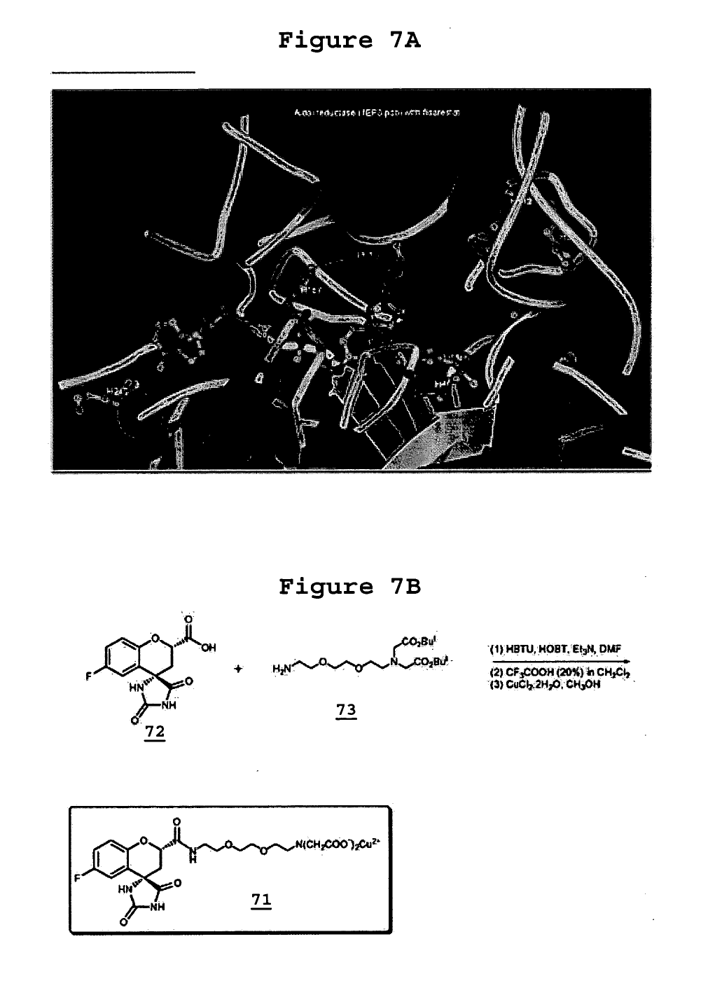

Since aldolase reductase is viewed as a target for the treatment of diabetes-2, we decided to design a modified aldolase reductase inhibitor. The three-dimensional structure of aldolase reductase with a bound inhibitor (fiderastat) was found in the Brookhaven Protein Data Bank (www.rcsb.org/pdb), which is hereby incorporated by reference (pdb file: 1EF3.pdb). The ribbon structure is shown in FIG. 7A, along with surface-exposed histidine residues that were identified with the aid of GRASP software on a SGI-O2 molecular modeling workstation. GRASP software is described in Nicholls et al., “Protein Folding and Association: Insights From the Interfacial and Thermodynamic Properties of Hydrocarbons,” PROTEINS: Structure, Function and Genetics, 11(4):281-296 (1991), which is hereby incorporated by reference, and an electronic version of the software is available at http://honiglab.cpmc.columbia.edu/grasp/, which is hereby incorporated by reference. An examination of the structure shown in FIG. 7A revealed that surface-exposed His187 is located about 13 Å from the inhibitor (fidarestat) binding site. Using this knowledge, we designed a fidarestat-based modified aldol reductase inhibitor having the formula PM-SP-MCG-(M), where PM is a fidarestat protein modulator, SP is a spacer having the formula —NH—CH₂—CH₂—(O—CH₂—CH₂)₂—, MCG is a metal chelating group having the formula —N(CH₂COO⁻)₂, and M is Cu²⁺. The fidarestat-based modified aldol reductase inhibitor 71 is shown in FIG. 7B, along with a method by which it can be synthesized from fidarestat intermediate 72 and iminodiacetic acid derivative 73. Fidarestat intermediate 71 can be prepared in accordance with the method described in Oka et al., J. Med. Chem., 43:2479-2483 (2000), which is hereby incorporated by reference; and iminodiacetic acid derivative 73 can be prepared in accordance with the method described in Roy et al., Org. Lett., 5:11-14 (2003), which is hereby incorporated by reference. The distance between the Cu²⁺ ion and the fidarestat-based inhibitor in modified aldol reductase inhibitor 71 is about 14 Å.

### Example 4

### Modified Inhibitors of 17-β-Hydroxysteroid Dehydrogenase

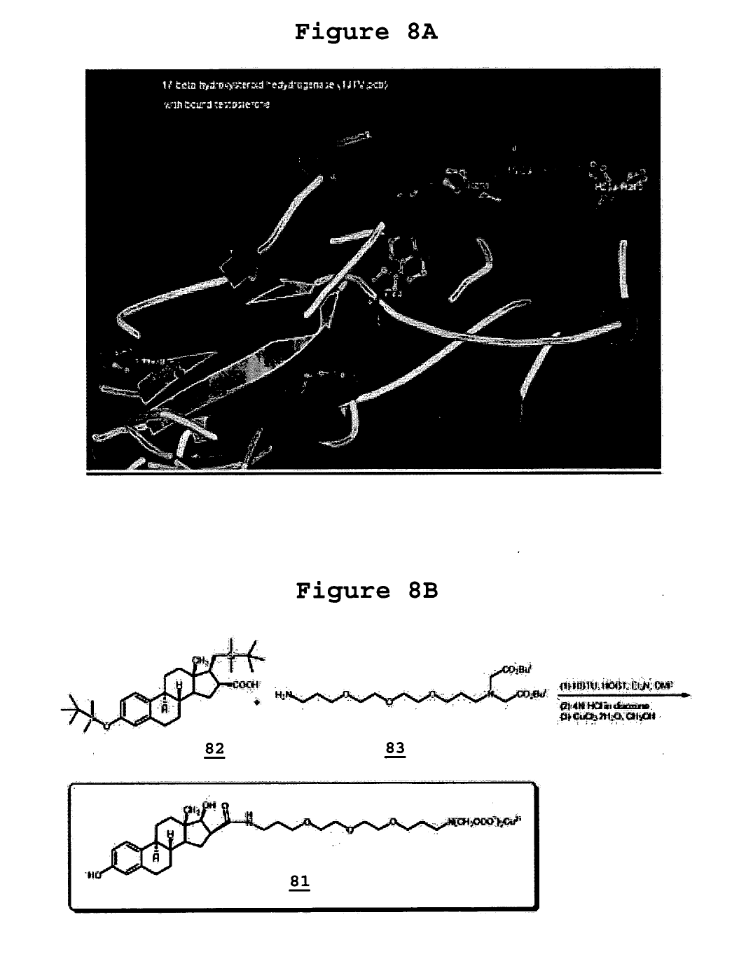

Since 17-β-hydroxysteroid dehydrogenase is a target for the treatment of breast cancer, we decided to design a modified 17-β-hydroxysteroid dehydrogenase inhibitor. The three-dimensional structure of 17-β-hydroxysteroid dehydrogenase with a bound testosterone was found in the Brookhaven Protein Data Bank (www.rcsb.org/pdb), which is hereby incorporated by reference (pdb file: 1JTV.pdb). The ribbon structure is shown in FIG. 8A, along with surface-exposed histidine residues that were identified with the aid of GRASP software on a SGI-O2 molecular modeling workstation. An examination of the structure shown in FIG. 8A revealed that surface-exposed His213 and His210 are located about 16.6 Å from the testosterone binding site. Using this knowledge, we designed an estradiol-based 17-β-hydroxysteroid dehydrogenase inhibitor having the formula PM-SP-MCG-(M), where PM is an estradiol-based protein modulator, SP is a spacer having the formula —NH—CH₂—CH₂—CH₂—(O—CH₂—CH₂)₃—CH₂—, MCG is a metal chelating group having the formula —N(CH₂COO⁻)₂, and M is Cu^{2 +}. The estradiol-based modified 17-β-hydroxysteroid dehydrogenase inhibitor 81 is shown in FIG. 8B, along with a method by which it can be synthesized from estradiol-based intermediate 82 and iminodiacetic acid derivative 83. Estradiol-based intermediate 82 can be prepared in accordance with the method described in Qiu, which is hereby incorporated by reference; and iminodiacetic acid derivative 83 can be prepared in accordance with the method described in Roy et al., J. Org. Chem., 65:3644-3651 (2000), which is hereby incorporated by reference. The distance between the Cu²⁺ ion and the estradiol-based inhibitor in modified 17-β-hydroxysteroid dehydrogenase inhibitor 81 is about 17 Å.

### Example 5

### Modified Inhibitors of Adenylate Kinase

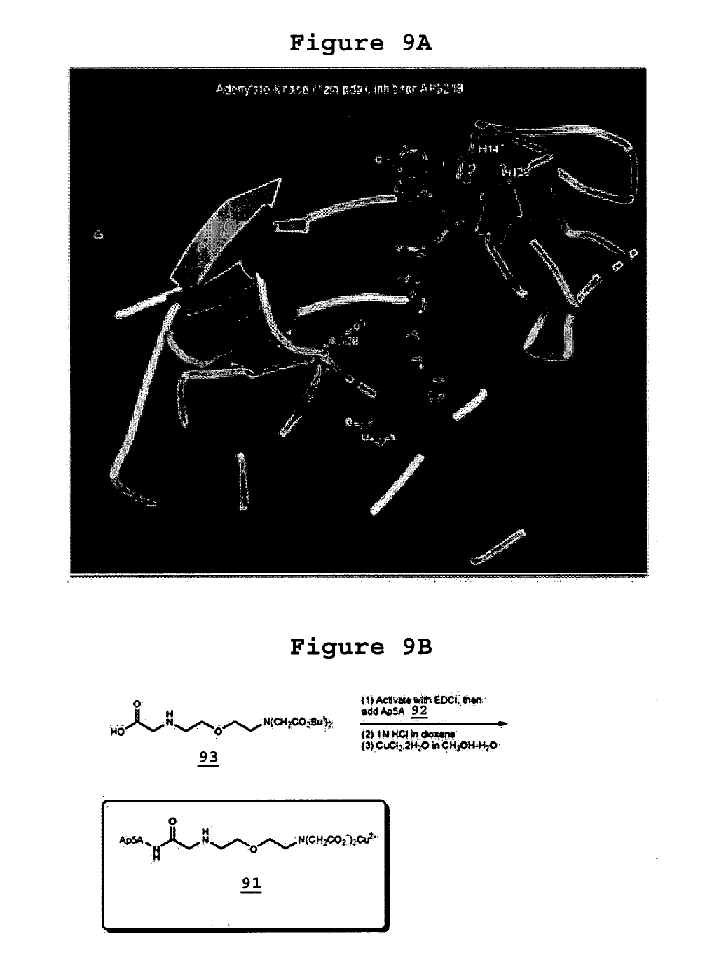

Since adenylate kinase is a target for the treatment of neurological disorders, we decided to design a modified adenylate kinase inhibitor. The three-dimensional structure of adenylate kinase with a bound AP5218 inhibitor was found in the Brookhaven Protein Data Bank (www.rcsb.org/pdb), which is hereby incorporated by reference (pdb file: 1zin.pdb). The ribbon structure is shown in FIG. 9A, along with surface-exposed histidine residues that were identified with the aid of GRASP software on a SGI-O2 molecular modeling workstation. An examination of the structure shown in FIG. 9A revealed that surface-exposed His138 and His143 are located about 7.4 Å from the AP5218 binding site. Using this knowledge, we designed an adenylate kinase inhibitor having the formula PM-SP-MCG-(M), where PM is an Ap5A (P₁,P₅-bis(adenosine)-5′-pentaphosphate)-based protein modulator, SP is a spacer having the formula —NH—CH₂—CH₂—O—CH₂—CH₂—, MCG is a metal chelating group having the formula —N(CH₂COO⁻)₂, and M is Cu²⁺. The Ap5A-based modified adenylate kinase inhibitor 91 is shown in FIG. 9B, along with a method by which it can be synthesized from Ap5A 92 and iminodiacetic acid derivative 93. Ap5A 92 is available from Sigma Chemical Company (St. Louis, Miss.); and iminodiacetic acid derivative 93 can be prepared in accordance with the method described in Roy et al., J. Org. Chem., 65:3644-3651 (2000), which is hereby incorporated by reference. The distance between the CU²⁺ ion and the Ap5A inhibitor in modified adenylate kinase inhibitor 91 is about 9 Å.

### Example 6

### Modified Inhibitors of Acetolactate Synthase

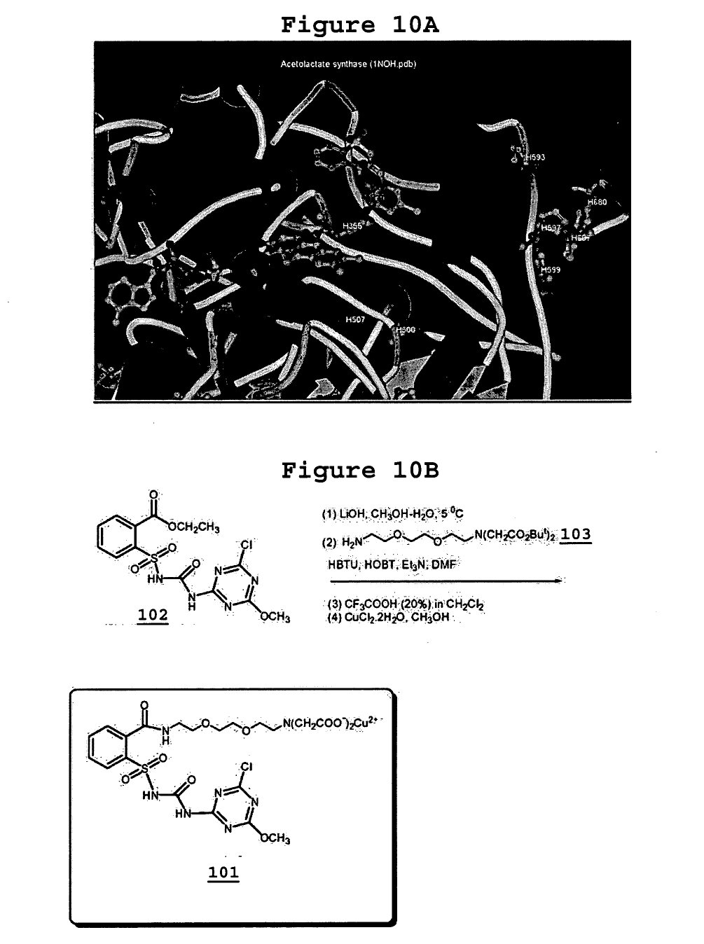

Since acetolactate synthase is a target for various commercially-important herbicides, we decided to design a modified acetolactate synthase inhibitor. The three-dimensional structure of acetolactate synthase was found in the Brookhaven Protein Data Bank (www.rcsb.org/pdb), which is hereby incorporated by reference (pdb file: 1NOH.pdb). The ribbon structure is shown in FIG. 10A, along with surface-exposed histidine residues that were identified with the aid of GRASP software on a SGI-O2 molecular modeling workstation. An examination of the structure shown in FIG. 10A revealed that surface-exposed His355 is located about 11.8 Å from an inhibitor binding site. Using this knowledge, we designed an acetolactate synthase inhibitor having the formula PM-SP-MCG-(M), where PM is a chlorimuron-based protein modulator, SP is a spacer having the formula —NH—CH₂—CH₂—(O—CH₂—CH₂)₂—, MCG is a metal chelating group having the formula —N(CH₂COO⁻)₂, and M is Cu²⁺. The chlorimuron-based modified acetolactate synthase inhibitor 101 is shown in FIG. 10B, along with a method by which it can be synthesized from chlorimuron-based intermediates (e.g., chlorimuron ethyl 102) and iminodiacetic acid derivative 103. Chlorimuron ethyl 102 can be prepared in accordance with the method described in Pang et al., J. Biol. Chem., 278:7639-7644 (2003), which is hereby incorporated by reference; and iminodiacetic acid derivative 103 can be prepared in accordance with the method described in Roy et al., Org. Lett., 5:11-14 (2003), which is hereby incorporated by reference. The distance between the Cu²⁺ ion and the chlorimuron-based inhibitor in modified acetolactate synthase inhibitor 101 is about 14 Å.

Although the invention has been described in detail for the purpose of illustration, it is understood that such detail is solely for that purpose, and variations can be made therein by those skilled in the art without departing from the spirit and scope of the invention which is defined by the following claims.

What is claimed:

1. A method for enhancing the effect of a protein modulator on a protein, said method comprising:
modifying the protein modulator so that the protein modulator binds with the surface of the protein.

2. A method according to claim 1, wherein the protein is an enzyme and wherein the protein modulator is an enzyme modulator.

3. A method according to claim 2, wherein the enzyme is a pathogenic enzyme.

4. A method according to claim 2, wherein the enzyme has a binding site for the enzyme modulator and wherein the enzyme modulator is modified such that it binds with the surface of the enzyme near the enzyme modulator binding site.

5. A method according to claim 4, wherein the binding site for the enzyme modulator is the enzyme's active site.

6. A method according to claim 4, wherein the binding site for the enzyme modulator is an allosteric site.

7. A method according to claim 2, wherein the enzyme has a binding site for the enzyme modulator and wherein the enzyme modulator is modified such that it binds with the surface of the enzyme within about 8-20 Å of the enzyme modulator binding site.

8. A method according to claim 2, wherein the enzyme has a binding site for the enzyme modulator and one or more histidine residues on the enzyme's surface near the enzyme modulator binding site.

9. A method according to claim 2, wherein the enzyme has a binding site for the enzyme modulator and one or more histidine residues on the enzyme's surface within about 8-20 Å of the enzyme modulator binding site.

10. A method according to claim 2, wherein the enzyme is selected from carbonic anhydrases, 17-β-hydroxysteroid dehydrogenases, tyrosinases, reverse transcriptases, cyclooxygenases, adenylate kinases, aldol reductases, and acetolactate synthases.

11. A method according to claim 2, wherein the enzyme is a carbonic anhydrase and wherein the enzyme modulator is an aryl sulfonamide.

12. A method according to claim 2, wherein the enzyme is a carbonic anhydrase and wherein the enzyme modulator is a benzene sulfonamide.

13. A method according to claim 2, wherein the enzyme is a 17-β-hydroxysteroid dehydrogenase and wherein the enzyme modulator is an estradiol inhibitor.

14. A method according to claim 2, wherein the enzyme is an adenylate kinase and wherein the enzyme modulator is P₁, P₅-bis (adenosine)-5′-pentaphosphate.

15. A method according to claim 2, wherein the enzyme is an aldol reductase and wherein the enzyme modulator is a fidarestat.

16. A method according to claim 2, wherein the enzyme is an acetolactate synthase and wherein the enzyme modulator is a sulfonylurea herbicide.

17. A method according to claim 2, wherein the enzyme is an acetolactate synthase and wherein the enzyme modulator is a pyrimidinylsulfonylurea herbicide, a triazinylsulfonylurea herbicide, an imidazolinone herbicide, or a triazolopyrimidine sulfonanilide herbicide.

18. A method according to claim 2, wherein the enzyme is an acetolactate synthase and wherein the enzyme modulator is a chlorimuron herbicide.

19. A method according to claim 2, wherein the enzyme is an acetolactate synthase and wherein the enzyme modulator is chlorimuron ethyl herbicide.

20. A method according to claim 1, wherein the protein has a binding site for the protein modulator and wherein the protein modulator is modified such that it binds with the surface of the protein near the protein modulator binding site.

21. A method according to claim 20, wherein the binding site for the protein modulator is the enzyme's active site.

22. A method according to claim 20, wherein the binding site for the protein modulator is an allosteric site.

23. A method according to claim 1, wherein the protein has a binding site for the protein modulator and wherein the protein modulator is modified such that it binds with the surface of the protein within about 8-20 Å of the protein modulator binding site.

24. A method according to claim 1, wherein the protein has a binding site for the protein modulator and one or more histidine residues on the protein's surface near the protein modulator binding site.

25. A method according to claim 1, wherein the protein has a binding site for the protein modulator and one or more histidine residues on the protein's surface within about 8-20 Å of the protein modulator binding site.

26. A method according to claim 1, wherein the protein modulator inhibits the protein's biological function.

27. A method according to claim 1, wherein the protein modulator activates the protein's biological function.

28. A method according to claim 1, wherein the protein modulator is modified so as to bind non-covalently to an amino acid residue on the surface of the protein.

29. A method according to claim 1, wherein the protein modulator is modified so as to bind to an amino acid residue on the surface of the protein via an electrostatic interaction.

30. A method according to claim 1, wherein the protein modulator is modified so as to bind to an amino acid residue on the surface of the protein via a metal complexation interaction.

31. A method according to claim 1, wherein the protein modulator is modified so as to bind to a non-cysteine amino acid residue on the surface of the protein.

32. A method according to claim 1, wherein the protein modulator is modified so as to covalently bind to an amino acid residue on the surface of the protein via a bond other than a disulfide bond.

33. A method according to claim 1, wherein the protein is a naturally-occurring protein.

34. A method according to claim 1, wherein the protein is not produced by site-specific mutagenesis.

35. A method according to claim 1, wherein the protein is not an acetylcholinesterase.

36. A method for modulating a protein's biological function, said method comprising:
contacting the protein with a protein modulator modified in accordance with a method according to claim 1.

37. A method for modulating a protein's biological function, said method comprising:
contacting the protein with a protein modulator modified in accordance with a method according to claim 23.

38. A method for modulating a protein's biological function, said method comprising:
contacting the protein with a protein modulator modified in accordance with a method according to claim 25.

39. A modified protein modulator having the formula:
PM-SP-(LK)ₚ-MCG-(M)_{q}
wherein PM is a protein modulator which interacts with an active site or allosteric site of a protein; SP is a spacer; LK is a linker; p is 0 or 1; q is an integer greater than or equal to one; MCG is a metal chelating group; and M is a metal ion.

40. A modified protein modulator according to claim 39, wherein PM is an acetolactate synthase inhibitor.

41. A modified protein modulator according to claim 39, wherein PM is a sulfonylurea acetolactate synthase inhibitor.

42. A modified protein modulator according to claim 39, wherein PM is a pyrimidinylsulfonylurea acetolactate synthase inhibitor.

43. A modified protein modulator according to claim 39, wherein PM is a chlorimuron acetolactate synthase inhibitor.

44. A modified protein modulator according to claim 39, wherein, taken together, -SP-(LK)ₚ-MCG-represents a tether having a length of from about 8 to about 20 Å.

45. A modified protein modulator according to claim 39, wherein PM is an acetolactate synthase inhibitor and wherein, taken together, -SP-(LK)ₚ-MCG-represents a tether having a length of from about 12 to about 16 Å.

46. A modified protein modulator according to claim 39, wherein PM is an acetolactate synthase inhibitor and wherein, taken together, -SP-(LK)ₚ-MCG-represents a tether having a length of about 14 Å.
